(19) United States
(12) Patent Application Publication
(10) Pub. No.: US 2025/0375711 A1
(43) Pub. Date: Dec. 11, 2025

(54) CONTROLLED INTERACTIVE AI-DRIVEN QUESTION-AND-ANSWER GENERATION BASED ON PHYSICAL GAME PIECES

(71) Applicant: Hasbro, Inc., Pawtucket, RI (US)

(72) Inventors: Samantha D. Weiser, Providence, RI (US); Gray Bright, Cranston, RI (US); Joseph P. Bradford, Providence, RI (US)

(21) Appl. No.: 19/309,506

(22) Filed: Aug. 25, 2025

Related U.S. Application Data
(63) Continuation-in-part of application No. 18/927,768, filed on Oct. 25, 2024.
(63) Continuation-in-part of application No. 18/972,798, filed on Dec. 6, 2024.
(60) Provisional application No. 63/546,152, filed on Oct. 27, 2023.
(60) Provisional application No. 63/607,381, filed on Dec. 7, 2023.

(51) Int. Cl. A63F 13/67; A63F 9/18

(52) U.S. Cl. CPC A63F 13/67; A63F 9/183

(57) ABSTRACT

Systems and methods herein are provided for delivering personalized trivia content in an interactive game using tangible game elements and a digital companion application. Players are enabled to select and scan multiple tangible game elements (e.g., via quick-response codes, ArUco markers, tags, or other identifiers), each representing a game parameter value (e.g., a topic or category), through a client-side user interface of the digital application to create different combinations. The user interface is coupled to a backend host that controls communications between the user interface and a database storing cache records including game content for particular combinations. The backend host queries the database to check for available game content for the selected combination (subject to certain constraints, such as game content not already previously presented to a user). If not, the backend host transmits a query to a generative artificial intelligence model trained to generate new game content.

### CROSS-REFERENCE TO RELATED APPLICATION(S)

The present application is a continuation-in-part of U.S. patent application Ser. No. 18/927,768 entitled “VALIDATION FRAMEWORK FOR QUESTION-AND-ANSWER SYSTEMS” and filed Oct. 25, 2024, which claims the benefit of U.S. Provisional Patent Application No. 63/546,152 entitled “VALIDATION FRAMEWORK FOR QUESTION-AND-ANSWER SYSTEMS” and filed Oct. 27, 2023. The present application is further a continuation-in-part of U.S. patent application Ser. No. 18/972,798 entitled “SYSTEM AND METHOD FOR A QUESTION GENERATOR RUNWAY FOR IMPROVING OUTPUT LATENCY IN QUESTION-AND-ANSWER SYSTEMS” and filed Dec. 6, 2024, which claims the benefit of U.S. Provisional Patent Application No. 63/607,381 entitled “SYSTEM AND METHOD FOR A QUESTION GENERATOR RUNWAY FOR IMPROVING OUTPUT LATENCY IN QUESTION-AND-ANSWER SYSTEMS” and filed Dec. 7, 2023. The content of the foregoing applications is incorporated herein by reference in their entirety.

### BACKGROUND

Trivia games are structured activities that test participants' knowledge across a broad array of subjects, such as history, science, literature, sports, or popular culture. These games traditionally exist in analog forms, such as board games or card-based systems, where individuals or teams compete by answering pre-written questions, typically drawn from physical cards or books. Players advance or score points by providing correct answers, with gameplay rules establishing victory conditions based on speed, accuracy, or accumulated score. Such analog trivia experiences are popular in social gatherings, educational environments, and competitive settings and typically rely on tangible components such as cards, dice, tokens, or boards to facilitate interaction.

Artificial intelligence (AI) models often operate based on extensive and enormous training models. The models include a multiplicity of inputs and how each should be handled. Then, when the model receives a new input, the model produces an output based on patterns determined from the data the model was trained on. Large language models (LLMs) are trained using large datasets to enable them to perform natural language processing (NLP) tasks such as recognizing, translating, predicting, or generating text or other content. One example of an existing LLM is ChatGPT. A recent trend in AI is to make use of general-purpose generative AI applications built on LLMs. An example of such an application is the ChatGPT family of OpenAI models. The general-purpose generative AI applications make use of a natural language chat interface for humans to make requests to the LLM. At the time of filing, general-purpose generative AI's initial attempt at responding to a user's queries is middling and requires query refinement from the user. Over the course of a given chat session, the user refines their queries (e.g., by rephrasing or specifying details), and the general-purpose model provides a more accurate and relevant response.

### BRIEF DESCRIPTION OF THE DRAWINGS

FIG. 1 is a diagrammatic view illustrating generally an environment of an example game platform that includes tangible game elements and a companion game application.

FIG. 2 is a diagrammatic view illustrating generally an environment of the game platform as applied to generate questions and answers for a trivia game.

FIG. 3 is a diagrammatic view illustrating generally an environment of the game platform interacting with a database that stores game content for a trivia game within cache records.

FIG. 4 is a flowchart illustrating an example method of generating questions and answers for a trivia game using the game platform.

FIGS. 5A and 5B are diagrammatic views illustrating generally a question generator runaway in accordance with the invention.

FIG. 6 is a flowchart illustrating a method of improving question-generating latency.

FIG. 7 is a diagram illustrating one embodiment of the architecture of the question generator runway as applied to a trivia game.

FIG. 8 is a diagram illustrating one embodiment of the architecture of the question generator runway as applied to snoozing outputs in a trivia game.

FIG. 9 is a diagrammatic view illustrating generally a validation process in accordance with the invention.

FIG. 10 is a flowchart illustrating a method of performing the validation process in FIG. 9.

FIG. 11A is a diagram illustrating one embodiment of the architecture of a validation framework as applied to validating language model outputs in a trivia game.

FIG. 11B is a diagram illustrating one embodiment of the architecture of the validation framework as applied to validating user inputs in a trivia game.

FIG. 12 is a flowchart illustrating an example method of generating validated questions and answers for a trivia game.

FIG. 13 is one embodiment of a front-end interface as applied to generating validated questions and answers for a trivia game.

FIG. 14 is one embodiment of a front-end interface displaying the generated validated questions and answers for the trivia game.

FIG. 15 is a screenshot of one embodiment of a front-end interface as applied to a trivia game.

FIG. 16 is a block diagram illustrating an example computer system, in accordance with one or more embodiments.

FIG. 17 is a high-level block diagram illustrating an example AI system, in accordance with one or more embodiments.

### DETAILED DESCRIPTION

Tabletop games have been popular forms of entertainment. Tabletop games often draw upon physical components such as cards, boards, dice, or tokens to structure gameplay. Among the many variations of tabletop games, trivia games (such as Trivial Pursuit) challenge players or teams to demonstrate their knowledge in a wide range of topics or categories. With the rise of digital platforms, digital interfaces (e.g., client-side user interfaces) oftentimes complement or replace physical components used in the tabletop games. Further, with the advent of artificial intelligence (AI), especially large language models (LLMs), there is a growing trend toward automating the creation and delivery of trivia content. Instead of relying solely on static, pre-written question banks, AI systems can be trained to generate new question-and-answer sets for specific topics, categories, and/or difficulty levels, thereby enabling game platforms to expand the game content pool.

However, direct communication of AI models with a client-side user interface (UI) introduces risks and inefficiencies. By placing AI access directly on a client device or application, platform operators lose control over the types and structure of inputs transmitted to the AI model. Users can submit random strings, malformed data, or deliberate attempts to circumvent moderation and content filters. For example, when users have uncontrolled or semi-structured access to the AI model, users are enabled to iteratively refine their prompts, experiment with ambiguous or otherwise undesirable inputs, and potentially “jailbreak” the AI to produce offensive, inappropriate, or otherwise policy-violating content. Open-ended text boxes or natural language entry fields in client-side trivia applications may trigger the AI to respond in unintended, and potentially disruptive, ways.

Further, each new prompt or category selection typically triggers a new call to the AI model. As a result, every new interaction, whether it involves switching to a different topic, selecting a new category, or even rephrasing a prompt, directly causes additional compute cycles to be consumed on the cloud servers. In environments where users experiment with rapid or repeated topic and category selections such as that of a trivia game, the cumulative cost can increase significantly, placing a significant computational burden on large-scale deployments or platforms experiencing heavy user activity.

As such, the inventors have developed systems (hereinafter “game platform”) and related methods to deliver personalized trivia content in a controlled interactive game environment. User interactions with tangible game elements (such as cards or tokens marking predefined topics and categories) are interpreted by a client-side user interface that obtains (e.g., scans, receives, reads) identifiers of the tangible game elements (which can map to a closed, finite set of allowed topic-category combinations; for instance, 1,800 possible pairs). When a user selects a topic-category combination (e.g., a topic and a category), the game platform cross-references the combination in a cache (stored per-user, per-user group, per-session, and/or globally) of previously generated question-and-answer sets specific to that topic-category combination. The game platform presents previously generated content existing in the cache where available (e.g., not previously presented and/or not within a similarity threshold of a previously presented question-answer set) and only transmits command set(s) to the AI model to generate a new question-answer set when the cache for the combination is depleted, outdated, and/or otherwise unavailable.

The backend host operates as an intermediary, so that no user interacts directly with the AI model. Thus, there is a reduced risk of prompt injection, jailbreaking, or exposure to inappropriate topics. The closed system design ensures that the AI model receives requests from the controlled input generated by the backend host. For example, the game platform rejects cards or identifier combinations that do not match a validated entry in the predefined set (e.g., if the backend host cannot recognize the scanned card, the backend host does not attempt to query the AI model). Additionally, when a topic-category combination is received, the cache for the topic-category combination is checked prior to querying the AI model. This reduces AI calls and increases the reuse of already generated and validated questions.

In addition, latency, or the delay between user input and system response, can significantly impact the user experience, particularly in scenarios where real-time interaction is used, as is the case with trivia games. One primary cause of latency in generative AI models within trivia games is the time-consuming nature of question generation. Interaction with a generative AI requires processing time. Users playing games tend not to be particularly forgiving of dead time or dead air. Relying on a generative AI to generate questions in a trivia game includes processing time delays, hindering the seamless flow of questions during gameplay. The inherently iterative nature of generative AI models, wherein multiple possibilities are explored before finalizing an output, further contributes to latency. While generative AI models do require processing time to operate, that processing time is predictable. Some embodiments described herein make use of the predictability of that processing time.

Moreover, as trivia games demand a continuous stream of questions to keep users engaged, users expect rapid responses to experience a dynamic, challenging session. Generative AI models may fall short of meeting the real-time demands of trivia games, leading to user frustration and disengagement. Additionally, the latency problem is exacerbated by the need to tailor questions to specific user inputs or preferences dynamically. As users interact with the trivia application, generating questions in response to their choices or areas of interest adds another layer of complexity.

A question generator runway of the game platform preemptively generates a pool of questions in advance. Upon receiving a user's request for trivia on a specific topic, the game platform anticipates future interactions, generating multiple questions and responses. The question generator runway uses a dynamic queuing mechanism, where the game platform reserves additional questions that are ready to be displayed upon the user's success in answering the currently displayed question. The dynamic queuing mechanism contributes to minimizing or otherwise reducing latency, as the game platform continuously generates questions in the background, maintaining a reservoir of content.

Further, due to the open-ended nature of trivia games, there is the potential for erroneous, misleading, or otherwise undesirable responses from the generative AI engine. The errors arise from various sources, such as inaccuracies in the training data, limitations in the model architecture, and/or the probabilistic nature of AI predictions. For example, the generative AI engine may lack the ability to verify the veracity of statements made by users. Without verification, the generative AI engine may generate responses based on false information provided by users. Another example occurs when the training data used to develop the generative AI engine contains biases or skewed representations. In that case, the generated content may inadvertently reflect those biases, potentially leading to inappropriate or inaccurate responses. Additionally, if the generative AI engine encounters a situation where the generative AI engine lacks adequate information to generate a response, the generative AI engine will attempt to infer or guess, potentially leading to inaccurate content. Another concern is when users provide input that is unconventional, vague, or entirely unrelated to the intended context, which challenges the generative AI engine's ability to generate appropriate responses. Input as described can be due to an attempt to jailbreak the generative AI engine, a form of hacking that aims to bypass an AI model's ethical safeguards and elicit prohibited information.

Even in potentially favorable circumstances, a generative AI typically provides what a user asks for in a literal sense and does not accommodate for what the user really wants to know. Humans will provide imprecise input that receives similarly imprecise output. For example, a human will request trivia questions on a certain topic, and the generative AI will take the path of least computation and provide a set of nearly identical, but technically different, questions. The human did not specify that the questions needed to be varied, and the model accordingly did not vary them. Further, a user can only do so much with a given query. Queries to generative models typically have character maximums or query buffers of a limited size in order to control execution speed. In such circumstances, a user's input may only be as specific as the query buffer allows.

In addition to being procedurally inefficient, using generative AI models for gameplay also results in another technical problem: the black-box nature of many AI models, where the internal workings of the model are not transparent. The opacity makes it difficult to understand and mitigate errors of the response. For example, a black-box model may make a decision based on spurious correlations in the data, but without insight into the model's reasoning process, it is challenging to identify and correct these errors. The technical problem is further compounded due to AI models operating on a next-best-token framework. The next-best-token framework predicts the next word or token in a sequence by considering the preceding words or tokens. For example, the AI model calculates the probability distribution over the possible next tokens and selects the one with the highest probability as the next output. The next-best-token framework may lead to outputs that deviate from the intended path because the model's decisions are based on local probabilities rather than a global understanding of the overall context or the user's ultimate goal. For example, if an AI model is asked to generate a story and the AI model encounters a vague prompt, the model may start generating content that diverges significantly from the user's intended narrative. The AI model may continue with a common or statistically likely sequence, but the sequence may not align with the specific direction or theme the user had in mind. Therefore, the next-best-token framework may struggle with maintaining long-term coherence and consistency in the generated text, as the framework focuses on immediate token predictions rather than the overall narrative structure.

Human intervention to correct the errors in the undesirable responses of the AI model is impractical, especially in real-time applications where quick/immediate responses are required. For example, in live gameplay, the immediacy and flow of interaction substantially affect the user experience. In trivia games, players expect rapid-fire questions and answers to maintain the pace and excitement of the game. If an AI model generates an incorrect or misleading question, waiting for a human to review and correct the question disrupts the flow of the game, causing frustration among players. Similarly, in Ouija board sessions, users interact with the AI in a continuous and fluid manner, seeking immediate responses to their queries. If the AI produces an inappropriate or nonsensical response, pausing the interaction for human correction would break the immersive experience and reduce the effectiveness of the application. Moreover, the volume of interactions in these gameplay scenarios is substantial due to multiple users engaging with the AI simultaneously.

To address the technical problems in AI-generated content, a validation framework used by the game platform uses an amalgamation of distinct AI models, each tailored to address specific facets of content assessment. The AI models are integrated within an architectural superstructure that allows for synchronized execution. The architectural superstructure facilitates the parallel execution of independent validation models. The independent validation models use pre-loaded query context to validate specific checks pertaining to the use of a main model (e.g., a generative AI model, GenAl, GAI). The pre-loaded query context functions as parameters that guide the distinct AI models in discerning compliance with predetermined model-driven conditions that limit undesirable input and output to/from the main model. The pre-loaded query context enables the system to dynamically adapt system validation criteria based on the unique characteristics of both the main model and the user input.

The validation framework enables various additional technical advantages. For example, the validation framework addresses the potential for erroneous, misleading, or otherwise undesirable responses from the generative AI engine by implementing multiple layers of validation on both the user input and the model output. For example, accuracy checks cross-reference the AI's responses with external knowledge databases and sources to ensure the accuracy of the information provided. Bias checks identify and mitigate biases present in the training data, reducing the likelihood of generating biased or skewed content. When the AI engine encounters situations where the AI engine lacks adequate information, the validation framework flags the instances and requests additional input from the user and/or provides a disclaimer about the potential uncertainty of the response.

Further, the validation framework mitigates the limitations of the next-best-token framework by using a global context to validate the response of the AI engine. By weaving together multiple validating models that operate in parallel, the validation framework ensures that each token prediction is checked against a broader context (e.g., the entire response, geographical location, time period, and so forth) defined by the multiple validating models. The validation framework validates the consistency of the AI's responses over extended interactions. The parallel validation is particularly advantageous for live gameplay, since the parallel structure enables the system to process multiple aspects of validation concurrently and thus reduces latency that would occur from validating the content against each aspect one at a time. Each model operates independently but is managed by a consensus module that determines the overall validity of the content by aggregating the results from the various validation models. Using the validation framework, a larger amount of content (e.g., trivia questions) can be generated over a shorter period of time.

While the present game platform is described in detail for use with trivia (such as Trivial Pursuit) game systems, the game platform could be applied, with appropriate modifications, to improve the playability of other applications, making the game platform a valuable tool for diverse applications beyond trivia games and supernatural communication sessions. The examples provided in this paragraph are intended as illustrative and are not limiting. Any other game referenced in this document, and many others unmentioned, are equally appropriate after appropriate modifications.

The invention is implemented in numerous ways, including as a process; an apparatus; a system; a composition of matter; a computer program product embodied on a computer-readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor”′ refers to one or more devices, circuits, and/or processing cores configured to process data, such as computer program instructions.

A detailed description that references the accompanying figures follows. The scope of the invention is limited only by the claims and the invention encompasses numerous alternatives, modifications, and equivalents. Numerous specific details are set forth in the following description in order to provide a thorough understanding of the disclosure. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### Overview of the Game Platform

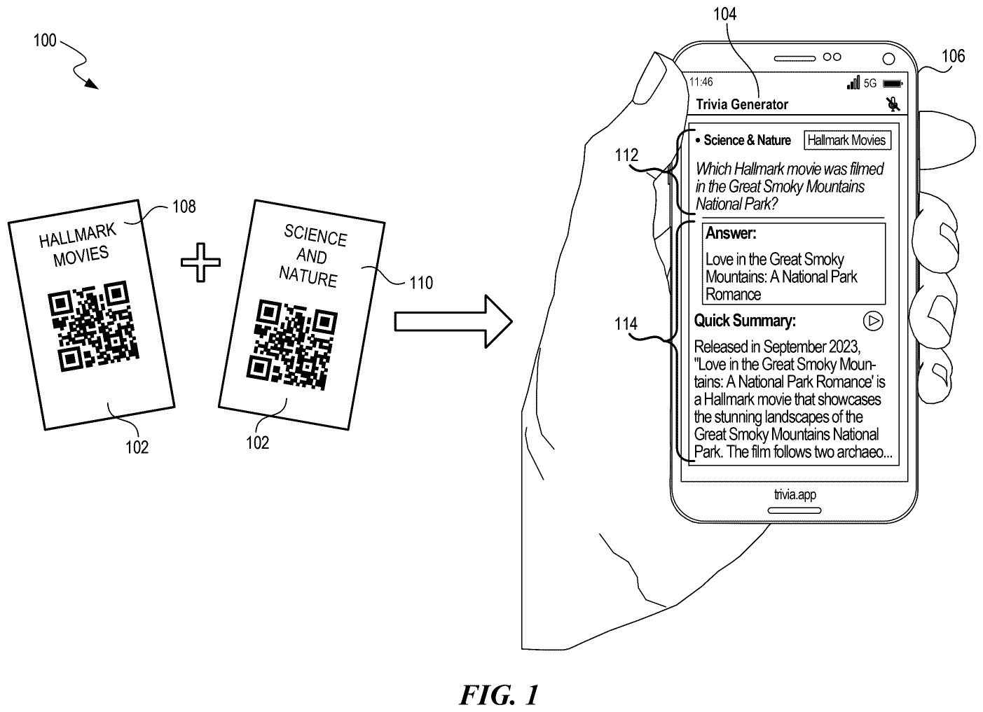

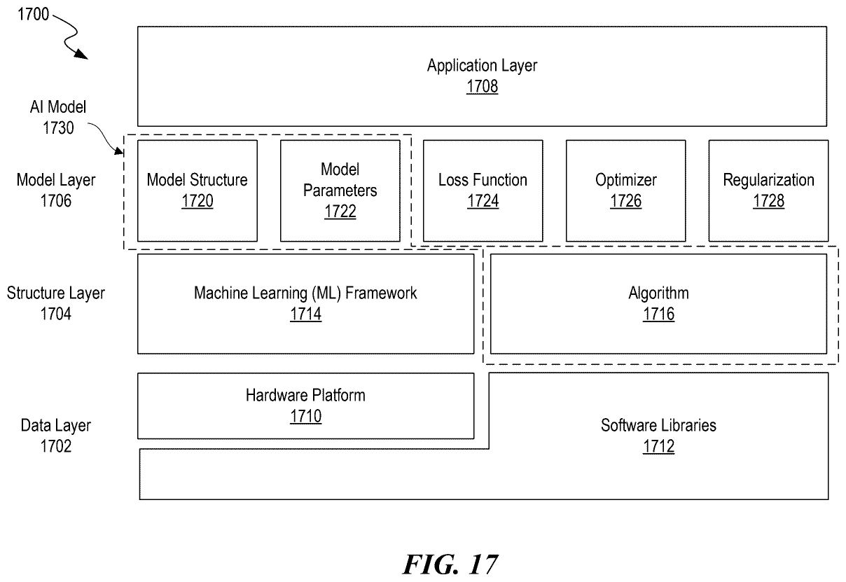

FIG. 1 is a diagrammatic view illustrating generally an environment 100 of an example game platform that includes tangible game elements 102 and a companion game application 104. The environment 100 is implemented using components of the example computer system 1700 illustrated and described in more detail with reference to FIG. 17. In some embodiments, implementations of example environment 100 include different and/or additional components or are connected in different ways.

The companion game application 104, in some embodiments, is a digital application that operates on a user device 106. The companion game application 104 directs the collection, transmission, and/or presentation of information associated with gameplay. For example, the companion game application 104 operates through a series of executable routines that receive/process scanned identifiers, request question-answer set generation or retrieval from remote services, and display game content (such as generated question-answer set(s)) to the user. In some embodiments, the companion game application 104 executes on a mobile operating system such as iOS or Android, while in others the companion game application 104 operates within a browser environment or on a gaming console. User devices 106 that support companion game application 104 include touchscreen smartphones, tablets, augmented reality headsets, laptop computers, and so forth.

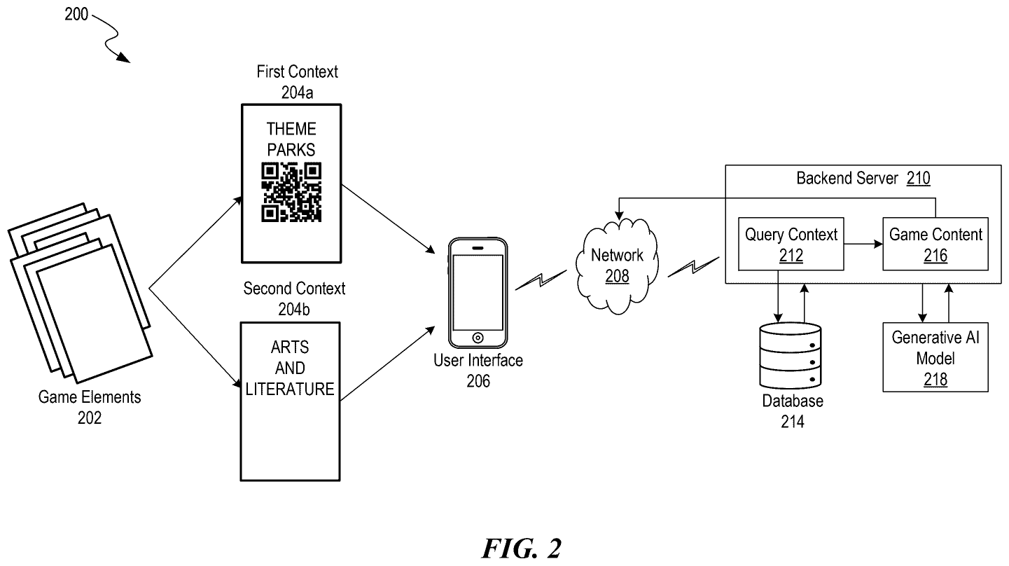

The companion game application 104 is organized in a client-server architecture that includes a backend host and a client-side user interface. The backend host executes game logic routines, manages communication between the client-side user interface and generative AI model(s), maintains persistent storage of game content and database records, and so forth. The client-side user interface operates on the user device 106 and enables presentation of interactive game content, scanning and/or processing of tangible game elements 102, reception of user input such as topic and category selections, and so forth. When a user selects values by scanning the tangible game elements 102, the client-side user interface transmits the scanned data to the backend host. The backend host structures and/or validates the received scanned data, compares the structured and/or validated scanned data against cached question-answer sets in a database (as discussed in further detail with reference to FIG. 2), and either retrieves the matching game content or interfaces with the AI model to synthesize new content. Resulting question and answer data is transmitted, via the backend host, back to the client-side user interface for display to the user.

The tangible game elements 102 indicate values of one or more game parameter types (i.e., a first game parameter type 108, a second game parameter type 110). For example, in FIG. 1, the first game parameter type 108 represents a topic, and the second game parameter type 110 represents a category. In some embodiments, the tangible game elements 102 are discrete physical tokens or objects associated with (e.g., embedded with) one or more machine-readable identifiers linked to parameter values of the game. For instance, a particular tangible game element 102 presents a visually printed quick-response (QR) code on one face representing a topic (i.e., the first game parameter type 108) and another visually printed QR code on the opposite face signifying a category (i.e., the second game parameter type 110). In some embodiments, the tangible game elements 102 are embedded with radio-frequency identification (RFID) tags or alphanumeric sequences readable via image recognition that represents the parameter values. The tangible game elements 102, for example, are dual-faced game cards, where one face indicates the first game parameter type 108, and another face (of the same or different game card) indicates the second game parameter type 110.

In some embodiments, when a user manipulates a tangible game element 102 on a device or within view of a scanning accessory, the identifier associated with first game parameter type 108 transmits data denoting a current topic selection to the companion game application 104. For instance, a tangible game element indicates “Dinosaurs” as a topic, while another tangible game element in the same set represents “Dragons.” In some embodiments, the second game parameter type 110 indicates category information for gameplay. Categories group questions into logical clusters, such as “History,” “Science,” “Popular Culture,” and so forth. In some embodiments, the tangible game elements 102 store multiple topic values and/or category values on each tangible game element 102.

The game platform generates game content such as a question 112 and/or an answer 114 (i.e., as a question-answer set). The question 112 represents a structured query or prompt generated based on the received topic and category parameter values. The answer 114 represents a structured response that answers the structured query or prompt. When a user selects topic and category parameter values by interacting with tangible game elements 102, the client-side user interface running on user device 106 transmits the values to the backend host. Upon receipt, the backend host examines its persistent storage to determine if a matching question-answer set exists within its cache indexed by the parameter combination. If no pre-existing question-answer set is available (e.g., matches), the backend host generates a query structured according to a defined data template and transmits the parameterized request to a generative AI model operating on remote or local computation resources to generate the question 112 and the answer 114.

The format of the answer 114 includes short-form responses, multiple-choice answers, and/or ordinal ranking formats that indicate the correct answer and/or other incorrect alternatives. For this example, though the correct answer of the example question is “The One Ring,” the answer 114 includes other incorrect alternatives such as “The Sword of Gondor,” “The Arkenstone,” and “The Silmaril.” The client-side user interface receives and displays the answer 114 with the corresponding question 112.

FIG. 2 is a diagrammatic view illustrating generally an environment 200 of the game platform as applied to generate questions and answers for a trivia game. The environment 200 is implemented using components of the example computer system 1700 illustrated and described in more detail with reference to FIG. 17. In some embodiments, implementations of example environment 200 include different and/or additional components or are connected in different ways.

The tangible game elements 202, which are manufactured physical artifacts such as cards, tiles, or tokens, each provided with a machine-readable identifier (as discussed in further detail with reference to the tangible game elements 102 in FIG. 1), enable user selection of parameter values by physical manipulation (such as scanning using the user device 106 in FIG. 1). First context 204a and second context 204b represent, respectively, the topic and category selected via interaction with different tangible game elements 202. For example, the first context 204a is “Theme Parks” selected from one card and the second context 204b is “Arts and Literature” selected from another card, thereby creating a combination (e.g., a query context combination, a topic-and-category combination) of “Theme Parks” and “Arts and Literature.”

User interface 206 executes on a user device (e.g., the user device 106 in FIG. 1) and enables the capture of machine-readable data from the tangible game elements 202 (e.g., via scanning, camera, near field communication (NFC), or manual input). The user interface 206, in some embodiments, prompts players when scans or selections are requested. The network 208 links user interface 206 with a backend server 210 using, for example, internet protocols.

Upon user selection of parameter values (e.g., transmitted as query context 212), the backend server 210 generates (e.g., constructs, forms, determines, selects) a structured request associated with the chosen topic (i.e., the first context 204a) and category (i.e., the second context 204b). The query context 212 stores information describing a particular trivia request within the environment 200 (e.g., the topic and category parameters collected from the user's interaction with the tangible game elements 202, additional metadata such as session information, player identifiers, or difficulty settings). The backend server 210 uses the query context 212 to identify which question-answer set to retrieve from database 214 and/or which data to supply to the generative AI model 218 to generate additional content.

The backend server 210 references database 214, which maintains a repository of cached or previously generated question-answer sets, to determine whether the query context 212 corresponds to (e.g., is the same as, within a similarity threshold of) existing game content previously presented to the user. The database 214 organizes the cached or previously generated trivia questions and answers according to the topic-category pairs or other query context data received from the backend server 210. If a matching and unused (e.g., unpresented, undisplayed) record is found, the database 214 returns the corresponding question-answer set to the backend server 210, which transmits the data to the user for display on the user interface 206. If all question-answer sets matching the topic-category combination have been presented to the user (at a per-user level, user group level, or global level) previously (or that the unpresented question-answer sets are within a similarity threshold of the presented question-answer sets), the backend server 210 uses a generative AI model 218 to synthesize a new question and answer (i.e., game content 216) and appends the game content 216 to database 214 for subsequent storage. The game content 216 is presented on the user interface 206 via the network 208.

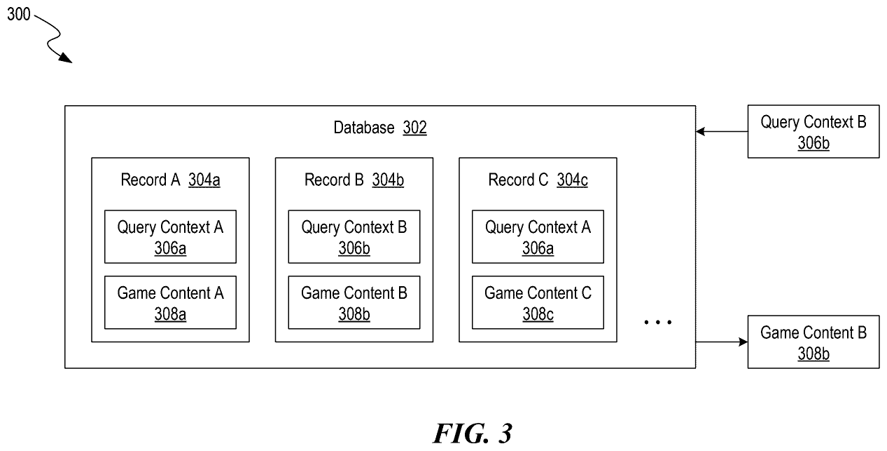

FIG. 3 is a diagrammatic view illustrating generally an environment 300 of the game platform interacting with a database 302 storing cache records 304 (i.e., a first cache record 304a, a second cache record 304b, a third cache record 304c, and so forth) to generate game content for a trivia game. The environment 300 is implemented using components of the example computer system 1700 illustrated and described in more detail with reference to FIG. 17. In some embodiments, implementations of example environment 300 include different and/or additional components or are connected in different ways.

Database 302 receives structured requests from the backend host and indexes the cache records 304 based on topic-category key pairs to expedite lookup. The cache records 304, including a first cache record 304a, second cache record 304b, and third cache record 304c, each representing a previously generated and/or stored question-answer set (e.g., a first game content 308a, a second game content 308b, and a third game content 308c, respectively), are mapped to a unique topic-category pair (e.g., a first query context 306a, a second query context 306b, and a third query context 306c, respectively). The backend host queries the database 302 using the parameter combination (e.g., the second query context 306b) provided by the user interface or generated via the tangible game elements, searching for a cache record 304 matching the current context. The query context 306 includes, in some embodiments, session IDs or unique player tags such that even if two users select the same topic and category in parallel games, each can be presented with different content.

When a matching cache record (e.g., the second game content 308b) is found that has not previously been presented to the user, the backend host transmits the associated game content to the client-side user interface for display. If no cache record exists for the selected parameter combination or if all existing cache records matching the selected parameter combination have been previously presented to the user, the backend host uses an AI model to generate a new question-answer set and then stores the new question-answer set as a new cache record 304 in database 302.

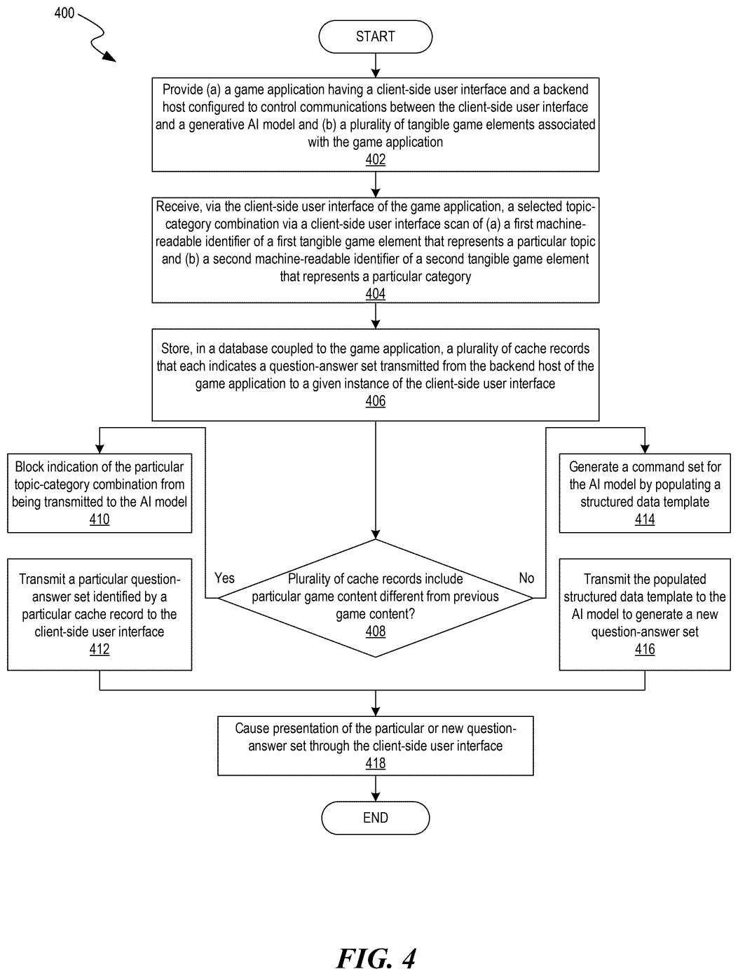

FIG. 4 is a flowchart illustrating an example method 400 of generating questions and answers (e.g., personalized trivia content) for a trivia game (or any interactive game environment) using the game platform. In some implementations, the method 400 is performed by components of example computer system 1700 (e.g., the game platform) illustrated and described in more detail with reference to the other figures. Likewise, implementations can include different and/or additional steps or can perform the steps in different orders.

In operation 402, the game platform provides (a) a game application having a client-side user interface and a backend host configured to control communications between the client-side user interface and a generative AI model and (b) a plurality of tangible game elements (e.g., cards) associated with the game application. Each tangible game element, in some embodiments, is provided with at least one identifier that represents a topic or category (i.e., a value of a game parameter type) of a question-answer set (i.e., game content). The identifier(s) associated with each tangible game element include, for example, a QR code printed on the tangible game element, an ArUco code affixed to the tangible game element, a universally unique identifier (UUID) encoded on the tangible game element, audio data associated with the tangible game element, an RFID tag embedded within the tangible game element, and so forth.

In operation 404, the game platform receives (or otherwise obtains), via the client-side user interface of the game application, a selected topic-category combination via a client-side user interface scan (or other type of inputs, such as manual input) of (a) a first identifier of a first tangible game element that represents a particular topic and (b) a second identifier of a second tangible game element that represents a particular category.

In operation 406, the game platform stores (or otherwise maintains), in a database coupled to the game application, a plurality of cache records that each indicates a question-answer set transmitted from the backend host of the game application to a given instance of the client-side user interface. Each question-answer set corresponds to each topic-category combination transmitted from the given instance of the client-side user interface to the backend host. For a single session, the given instance uniquely identifies one or more game sessions associated with a game account of the game application. For repeat players and ongoing user accounts, a particular user identifier (such as a unique account ID, email address, device identifier, or third-party authentication token) is received via an application programming interface (API) call transmitted via the backend host. The plurality of cache records is associated with the particular user identifier.

In some embodiments, the database maintains, for each cache record of the plurality of cache records, metadata indicating a difficulty level of respective game content. For example, the database receives, via the user interface of the game application, an indication of a predefined difficulty level. The particular cache record includes respective metadata that indicates the predefined difficulty level. Therefore, question-answer sets presented to users align with the expected difficulty level and/or skill of the user.

In operation 408, the game platform determines whether the plurality of cache records associated with the selected topic-category combination includes a particular question-answer set that is different from previous question-answer sets presented previously through the client-side user interface. For exact match detection, the backend host determines whether there is an identical question text or answer content between each question-answer set in the plurality of cache records and previous question-answer sets. For example, a match beyond a certain string equality threshold causes the question-answer set to be excluded from presentation.

In some embodiments, in making this determination, the game platform calculates a similarity metric between the previous question-answer sets and the question-answer sets within the plurality of cache records. To address near-duplicate or paraphrased content, the game platform generates a semantic similarity score. For example, both the previous question-answer sets and the question-answer sets within the plurality of cache records are transformed into vector embeddings using NLP models (such as transformer-based sentence encoders). The game platform determines the cosine similarity between these vectors. If two questions have a similarity score above a specified threshold (such as 0.85 or higher), the questions are considered too similar, and the particular question-answer set within the plurality of cache records is skipped or otherwise blocked from presentation. For example, under the topic “World Capitals” with category “Geography,” if a user has previously been shown “What is the capital of Japan?” and a candidate question-answer set is “Name the capital city of Japan,” the score is high, so the question is filtered out. The game platform, in some embodiments, tunes the threshold or uses a tiered rule set depending on the subject matter and player experience goals.

If there is a particular question-answer set that is different from previous question-answer sets presented previously through the client-side user interface, in operation 410, the game platform blocks, via the backend host, an indication of the selected query context combination from being transmitted to the AI model. In operation 412, the game platform transmits, via the backend host, the particular game content indicated by a particular cache record of the plurality of cache records to the client-side user interface. The particular cache record is associated with the selected query context combination. The AI model is applied to the selected topic-category combination subsequent to or prior to scanning (a) the first machine-readable identifier of the first tangible game element and (b) the second machine-readable identifier of the second tangible game element.

If there is not a particular question-answer set that is different from previous question-answer sets presented previously through the client-side user interface, in operation 414, the game platform generates, via the backend host, a command set for the AI model by populating a structured data template with data corresponding to the selected topic-category combination. The structured data template includes placeholder tokens configured to be replaced with the data corresponding to the selected topic-category combination at respective locations of the placeholder tokens within the structured data template. In operation 416, the game platform transmits the populated structured data template to the AI model. The AI model is trained to generate a new question-answer set in accordance with the selected topic-category combination. The AI model outputs, responsive to receiving the selected topic-category combination, the particular question-answer set, a summary of the particular question-answer set, an explanation describing the particular question-answer set, a hint generated based on at least one keyword or fact related to the particular question-answer set, and/or a citation to one or more sources used to validate the particular question-answer set.

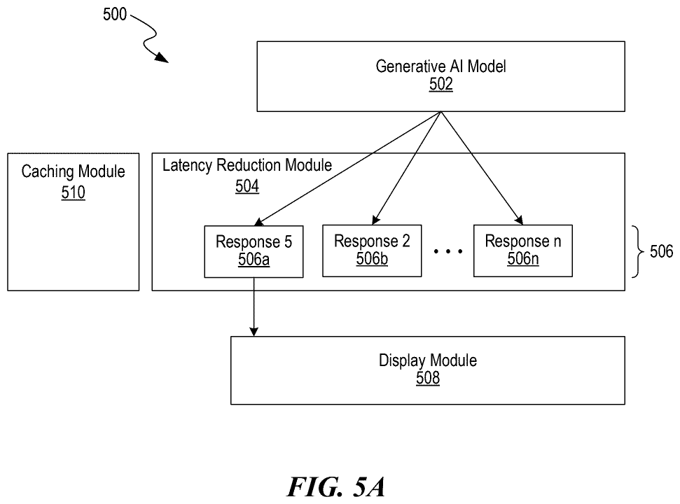

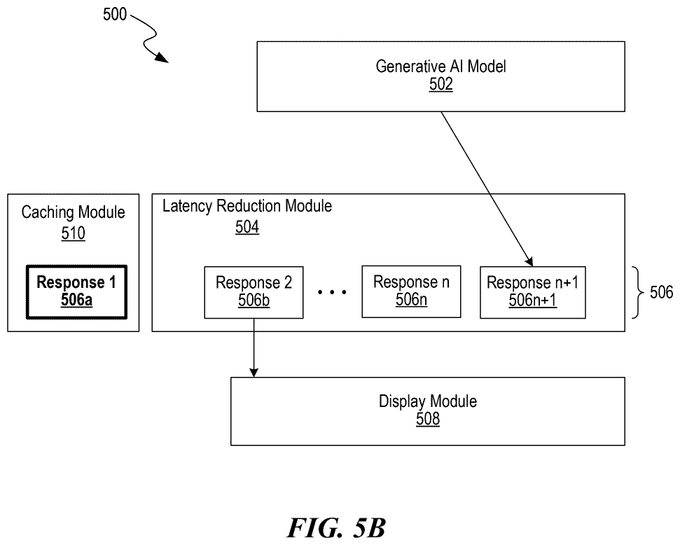

In operation 418, the game platform causes presentation of the new question-answer set through the client-side user interface. To reduce user-perceived latency associated with game content generation (which is further discussed with reference to FIGS. 5A-8), in some embodiments, in response to causing the presentation of the particular game content through the user interface, the game platform automatically transmits, via the game application, an indication of the selected query context combination to the AI model. The game platform receives, from the AI model, a replacement game content generated responsive to the selected query context combination. The AI model generates the replacement game content during an expected user interactivity time associated with the particular game content.

In some embodiments, the game platform generates a runway of questions collectively for all (or multiple) users. For example, the game platform maintains a count of unused question-answer sets for each topic-category combination collectively for multiple users. The generation of the command set is triggered when a collective count for a particular topic-category combination across the multiple users falls below the predetermined threshold. In some embodiments, where a runway of questions is generated, when the user nears expending all of the question-answer sets in a given category/topic (or other game parameter type), the game platform causes generation of new question-answer sets. For example, the game platform determines, via the backend host, that a count of unused question-answer sets stored in the database for a particular topic-category combination is less than a predetermined threshold. In response to the determination, the game platform generates, via the backend host, an additional command set for the AI model to generate one or more additional question-answer sets for the particular topic-category combination. The game platform stores the one or more additional question-answer sets in the database.

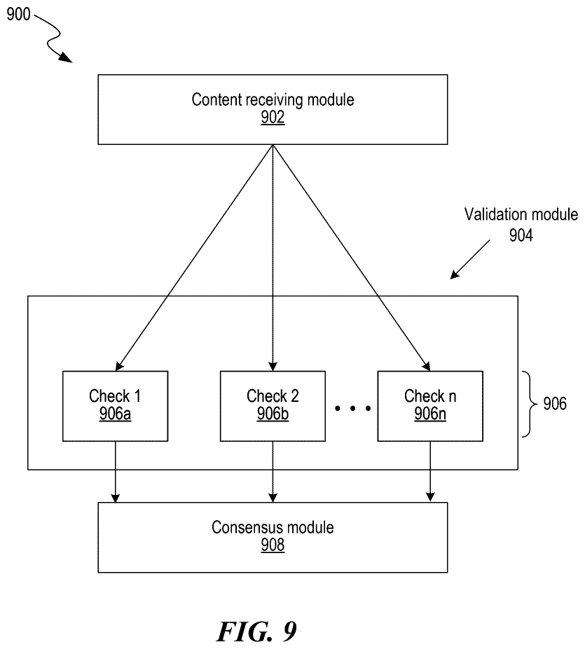

To control communications between the client-side user interface and the AI model, the game platform blocks, via the backend host, transmission of user-supplied input received from the client-side user interface that is different from the populated structured data template to the AI model. In some embodiments, the game platform validates (as further discussed with reference to FIGS. 9-15) that the particular game content generated via the AI model satisfies predetermined criteria, and in response to said validation, causes the presentation of the particular game content through the client-side user interface.

To validate game content prior to causing presentation of the particular game content through the user interface (as further discussed with reference to FIGS. 9-15), the game platform, in some embodiments, evaluates, using one or more validation models, the particular game content to determine satisfaction of the particular game content with a predetermined model-driven condition. The predetermined model-driven condition is directed by a query context assigned to the one or more validation models. In response to the particular game content failing to satisfy the predetermined model-driven condition, the game platform automatically transmits, via the backend host, an indication of the particular topic face and the particular category face to the AI model.

In some embodiments, the client-side user interface receives or otherwise obtains, for one or more game content indicated by one or more cache records in the plurality of cache records, user feedback that indicates alignment of the one or more game content with a set of criteria. Responsive to the user feedback failing to satisfy a predefined threshold associated with the set of criteria, the game platform automatically removes the one or more cache records from the database.

### Generating Game Content for the Game Platform Using a Question Generator Runway

FIGS. 5A and 5B are diagrammatic views illustrating generally a question generator runaway 500. As shown in FIG. 5A, the question generator runaway 500, in some embodiments, includes generative AI model 502 comprising of neural network-based architecture, such as an LLM, that is configured to generate responses based on inputs from a user. In some embodiments, the generative AI model 502 generates the responses based on a user input, which is received via an application that includes a user interface. Responses 506a-506n are assigned an expected user interactivity time, which estimates the average time a user would take to respond to the corresponding response 506a-506n. For example, in the context of a trivia game, the expected user interactivity time is the time a user would take to read and answer a particular trivia question.

In some embodiments, the calculation of expected user interactivity time in the trivia game system involves a multi-faceted approach that utilizes a combination of historical data and real-time factors to dynamically determine how long users are likely to engage with specific responses. The algorithm considers the inherent complexity of each trivia question, assessing factors such as intended difficulty, linguistic complexity, question length, and the potential presence of multimedia elements. Additionally, in some embodiments, real-time variables, such as network latency, device processing capabilities, and system load, are also factored into the calculation. In some embodiments, the system learns from patterns in historical user engagement, identifying trends and adjusting the system's predictions of expected user interactivity time for each response accordingly.

The responses of the generative AI model 502, in some embodiments, are in a string format. However, in scenarios where JSON formatting is required, the configuration is specified within the query context. As is described in greater detail below, in the context of a trivia game, the generative AI model 502 is configured to receive a topic request from a user in some embodiments. The responses from a generative AI model 502, in some embodiments, are in the form of a trivia response (including a question, incorrect answers, and the correct answer). A trivia response specifically pertains to the entirety of one or more trivia questions and the corresponding set of multiple-choice answers and/or schedule of accepted answers (in view of short answer or fill-in-blank type trivia).

The responses generated by the generative AI model 502 are transmitted into a latency reduction module 504. In some embodiments, the latency reduction module 504 includes responses 506. In the context of a trivia game, the responses 506 are trivia questions and answers. In some other embodiments, the latency reduction module includes a plurality of responses, 506a, 506b, and so on through 506n, for a total of n responses, where n equals the number of responses. Responses 506a-n are assigned an expected user interactivity time.

One of the responses 506 received by the latency reduction module 504 is then transmitted to the display module 508, where the first displayed response 506a is displayed to the user via the user interface on the application. In some embodiments, the application is a trivia game system, wherein the first displayed response 506a sent to the display module 508 appears as a trivia question, facilitating user engagement. The other responses 506b-n that are not displayed are instead reserved within the application and readied.

Once the user interacts with the first displayed response 506a, one of the responses 506b-506n reserved in the latency reduction module 504 is then subsequently transmitted to the display module 508, where one of the responses 506b-506n is displayed to the user via the user interface on the application. Again, in some embodiments, the application is a trivia game system, wherein the first displayed response 506a sent to the display module 508 appears as a trivia question, facilitating user engagement.

As shown in FIG. 5B, in some embodiments, once the user interacts with the first displayed response 506a, a predetermined input is automatically sent to the generative AI model 502 to cause the generative AI model 502 to generate a subsequent response 506n+1. The subsequent response 506n+1 is generated by the generative AI model 502 during the expected interactivity time of the first response 506a. Thus, the processing time to generate subsequent response 506n+1 is hidden or concealed from the user while the user interacts with the first response 506a.

In some embodiments, a predetermined input in the context of the trivia game involves providing the generative AI model with specific parameters to guide the subsequent output generation. This input is carefully designed to maintain thematic consistency and prevent unnecessary repetition. For example, if a user initiates a trivia session with a user-requested topic, the predetermined input includes the same topic as a reference point for generating subsequent questions. This ensures coherence within the session and aligns with the user's initial interest.

In some embodiments, the predetermined input further includes additional query context, such as previously generated questions during the session. By considering the user's interaction history, the generative AI model avoids regenerating identical or similar questions, creating a more engaging and dynamic trivia experience.

For example, the subsequent response 506n+1 from a generative AI model 502, in some embodiments, is in the form of a trivia response (including a question, incorrect answers, and the correct answer). Similarly to that of the other responses 506, the subsequent response 506n+1 also is assigned an expected user interactivity time. The subsequent response 506n+1 is reserved in the latency module 504. In some embodiments, once the user interacts with the displayed response 506, the first displayed response 506a is removed from the latency reduction module 504 and transferred to the caching module 510.

In some embodiments, the caching module 510 is designed to store and manage previously generated trivia responses in a cache, which acts as a temporary, dynamic storage mechanism. Furthermore, the caching module 510 prevents redundant outputs. The caching module 510 is allocated in different locations, including a dedicated memory space on a host server associated with a specific user, on the user's local device, or in a session-only capacity within the generative AI's query buffer.

The query buffer, a dynamic storage region employed by the generative AI model 502, maintains contextual relevance between subsequent responses and preserves session history. The query buffer operates as a temporary holding area for queries, responses, and associated metadata during a trivia session. In some embodiments, the query buffer's primary function is to facilitate quick access to historical data, enabling the generative AI to make informed decisions based on previous interactions by applying the query context or session history to user topic requests.

In some embodiments, the caching module 510 uses vectorization techniques to transform the responses 506 stored within the caching module 510 into reduced representations, reducing data size while maintaining the contextual relevance of responses 506 stored within the caching module 510. In some embodiments, in the context of a trivia game with generative artificial intelligence (AI), maintaining contextual relevance of responses 506 is achieved by capturing semantic relationships and contextual references within the responses 506. In some embodiments, the vectorization process involves encoding the responses into mathematical vectors, preserving essential features that contribute to contextual relevance.

In other embodiments, the caching module 510 implements a two-way function encryption strategy. Upon a response 506 being transmitted to the caching module, each response 506 undergoes encryption to reduce the data size of the response 506. In some embodiments, the two-way function encryption strategy involves using code words or phrases as a form of encryption, similar to a code book. For instance, replacing recurring phrases within the response 506 such as “When was the” with a compact code such as “0010” allows for data-size reduction, since only four bits are used to represent a string. With a predefined key or code book, the system can efficiently revert these coded representations back to their original forms. The encrypted ciphertext is generally more compact than the original plaintext, leading to a reduction in data size. The reduction occurs because the encryption algorithm transforms the response 506 into a format that is less redundant and more efficiently represents the response 506. Consequently, the encrypted response 506 consumes less storage space within the caching module 510.

In other embodiments, the caching module 510 implements a one-way function encryption strategy, such as hashing techniques. When a response 506 is subjected to hashing, the hash function processes the response 506 and produces a fixed-size output. In some embodiments, the hash value is unique to the response 506, and even a small change in the input (e.g., a different response 506) will result in a significantly different hash. In some embodiments, the hashing technique creates a query context that includes hashed representations of previously generated questions, the generative AI model 502 can hash each new response 506 it generates and compare the response 506 to the hashed context.

In some embodiments, the cache management relies on a dynamic cache replacement policy. The cache replacement policy systematically tracks the usage patterns of stored responses 506, prioritizing the retention of recently accessed elements. The cache replacement policy not only enhances the efficiency of response retrieval but also mitigates the impact of storage limitations. The cache replacement policy dynamically adjusts the items stored in the cache, ensuring a more efficient utilization of available resources and thus reducing latency in gameplay. In some embodiments, outputs that are identified as newer or more frequently accessed are stored in a cache. On the other hand, outputs that are older or less frequently accessed are removed from the cache. For example, the cache replacement policy considers the time of creation or last access, providing temporal context for the trivia responses. Additionally, in some embodiments, the cache replacement policy assigns different weights or priorities based on specific criteria, such as user preferences, question relevance, or other contextual factors.

The generated responses 506 of the generative AI model 502, in some embodiments, are directed by query context. Query context includes both the query to the generative AI model (e.g. the user-requested topic) along with the query's contextual information. The query's contextual information controls the manner in which the queries should be interpreted. For example, the query's contextual information includes temporal factors that consider the timing and sequence of queries to maintain coherence and relevance over time. Additionally, in some embodiments, user-centric factors delve into individual preferences, historical interactions, and past queries, facilitating personalized and user-specific responses. In some embodiments, factors such as demographics and preferences enhance the contextual understanding of queries. External factors, like current events or trending topics, further contribute to the query's contextual information, aligning responses with the broader context of the user's environment.

In some embodiments, the generative AI model 502 precludes the redundant display of trivia outputs during a single session. Using the query context that utilizes the cache, the generative AI model 502 ensures that if a particular trivia response is already stored within the cache and has been generated during the ongoing session, the particular trivia response will be withheld from subsequent display on the user interface. The feature minimizes unnecessary repetition within a trivia game environment, optimizing the user's engagement with diverse trivia content throughout the gaming session. In some embodiments, the implementation involves real-time checks against the caching module 510, allowing the system to dynamically adjust the responses presented to the user based on the evolving context of the ongoing session. In some embodiments, the generative AI model 502 precludes the redundant display of trivia outputs across all sessions.

In some embodiments, each response generated by the AI model 502 is associated with specific performance metrics or metadata, such as time of generation. These metrics serve as quantitative indicators of the response's redundancy. The cache, designed to store the responses along with their corresponding metrics, undergoes regular updates. When a new response is generated, the associated metric is appended to the cache entry. The cache then establishes a traceable link between the response and the response's metrics.

In some embodiments, the query context is hidden from the user. The hidden parameter, while not explicitly specified in user input, enables the model to produce content that adheres to the specific pre-determined model-driven conditions, such as excluding duplicative inputs, per session or across multiple or even all sessions. In some embodiments, the hidden parameter functions in the same way as a pre-defined query context. Both the pre-defined query context and the hidden parameter guide the generated responses based on predetermined model-driven conditions.

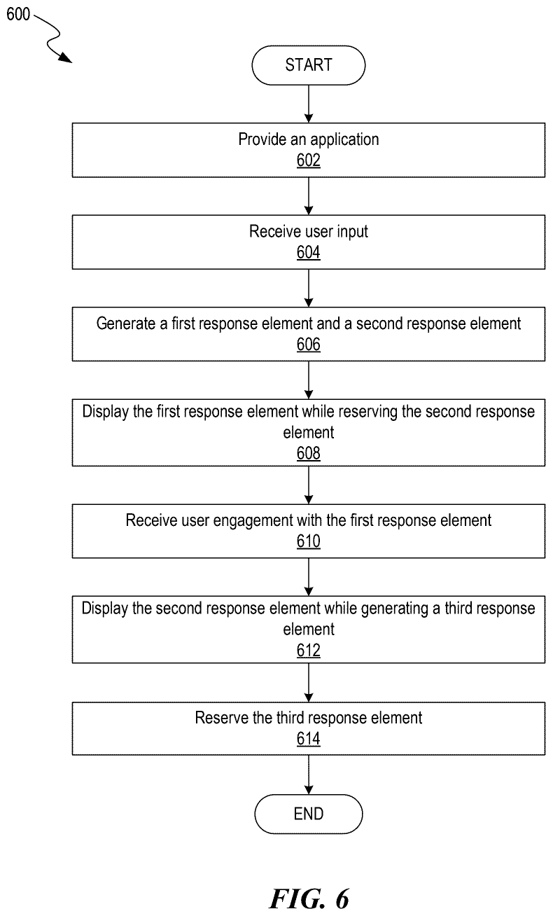

FIG. 6 is a flowchart illustrating a method of improving question-generating latency. The process initiates with providing an application 602. In some embodiments, application 602 is a trivia game system.

The application 602 then receives user input 604. In some embodiments, the content consists of a topic request in the context of a trivia game. For example, the user input 604 is a specific category, theme, or subject matter (e.g., “Kangaroos”) that the user would have the trivia questions tailored to relate to.

Subsequently, the received user input 604 is input into a generative AI model employing a neural network-based architecture. Reference to AI engines herein employs either platform native models or external APIs. External APIs (e.g., ChatGPT, MidJourney, Llama, Bard, etc.) are communicatively coupled to a game platform.

Once in the generative AI model, in step 606, the generative AI model will generate a response, consisting of at least a first response element and a second response element. In some embodiments, each response element is a trivia question and answer that is related to the received user input 604. For example, if the user requests a certain topic (e.g., “Kangaroos”), the generative AI model will generate 606 a question related to the received user input 604 (e.g., “What is a group of kangaroos called?”), and also include the answer, ensuring that each question is paired with a correct and contextually appropriate answer (e.g., “Mob”).

The first response element is then displayed, and the second response element is reserved within the application in step 608. In some embodiments, the first response element is displayed on the user interface to facilitate user engagement. In some embodiments, the second response element is reserved within the application provided 602. In some embodiments, the application is a trivia game system, wherein the first response element appears as a trivia question on the front-end user interface, facilitating user engagement. The front-end interface serves as the medium through which the user interacts with the system. In some embodiments, the front-end interface encompasses visual or auditory elements to facilitate user engagement. In step 608, depending on the specific context and user preferences, the system chooses to disclose either the question and/or the question's corresponding answer, catering to individual user needs or preferences. The other response elements, such as the second response element, that are not displayed, are instead reserved within the application and readied.

In some embodiments, the provided application 602 employs at least one validation model to evaluate the generated response elements before display, accepting or rejecting the response for display. The validation model(s) operate based on factors such as contextual relevance, coherence, and adherence to predefined quality criteria. Each validation model is assigned a distinct pre-loaded query context.

In some embodiments, by leveraging the expected user interactivity time, the system assesses the number of questions to queue in the application. Then, by factoring in the expected validation time through the validation model(s), the system dynamically adapts the number of questions in the question generator runway to maintain a reduced latency. In instances where responses are rejected by the validation model(s), the system is able to backfill precisely the required number, ensuring a continuous and engaging user experience with validated questions and reduced latency.

Each of the validation model(s) reviews some predefined aspect of the input to the application. A distinctive element of each of the validation model(s) is the pre-loaded query context that is employed along with the input to the application. In some embodiments, the validation model(s) employ varied model architecture and training sets. In some embodiments, the same model architecture and training set are employed for the validation model(s).

In some embodiments, one of the validation model(s) includes a topic check. The topic check is pre-loaded with a query context that encompasses an extensive list of prohibited topics, encapsulated in a structured data format such as JSON. Through training techniques such as NLP and topic modeling, the model is adept at identifying and denying queries pertaining to these topics in a variety of means, such as utilizing algorithms like support vector machines (SVM) for classification. In some embodiments, through a process of iterative analysis, the topic check dissects the deny list, discerning patterns and underlying characteristics associated with the proscribed topics. In some embodiments, the discernment process involves the extraction of semantic, syntactic, and contextual features from textual data, enabling the model to distinguish between permissible and impermissible content.

For example, a trivia game under a particular configuration is not interested in including questions about serial killers. The topic block is approachable either explicitly (e.g., the user asked for questions about serial killers) or implicitly (e.g., the user asked for questions about a specific person who fits the definition of serial killer). However, a given topic requested may be “The Silence of the Lambs,” a film that concerns a fictional serial killer, Hannibal Lecter. In such a circumstance, in some embodiments, a fictional or entertainment-related bypass is enabled by framing the topic check as to whether the trivia question is more related to the prohibited topic (e.g., serial killers) or more related to an allowed topic (e.g., entertainment and film).

In some embodiments, topic checks are executed individually and in parallel (e.g., each topic, serial killers or otherwise, is independently evaluated), and in some embodiments, multiple topics are screened simultaneously with one set of pre-loaded query context. A similar principle applies to other validation model(s) described below.

In some embodiments, one of the validation model(s) includes a localization check. The pre-loaded query context for the localization check comprises geospatial data in a standardized format, allowing for precise geographical determination. Through geospatial algorithms, the model assesses whether the generated content remains relevant and appropriate for the geographic location of the users or user profiles initiating the query, using techniques such as coordinate-based calculations and geofencing.

Appropriateness is structured either as cultural awareness or cultural taboo. In such cases, the pre-loaded query context includes variables that are determined by the location of the user. An example pre-loaded query context is “Is topic X (as received from the user input) a polite topic for general discussion in Geographic region Y (country, state, metro area, etc. of the user).” Or similarly, “Is topic X (as received from the user input) something that people in Geographic region Y (country, state, metro area, etc. of the user) are familiar enough for a trivia question of difficulty Z (easy, medium, hard, etc.).”

In some embodiments, one of the validation model(s) includes a hallucination check. The pre-loaded query context for the hallucination check specifies parameters for evaluating data veracity and coherence, allowing the check to use techniques such as sequence-to-sequence modeling and attention mechanisms. If the model detects a deviation from established criteria, the model interrupts the query and invokes the generative AI model to restart, employing mechanisms such as process control to determine whether the model rectifies the erroneous data. The hallucination check operates on the premise that generative AI output is produced on a per-character basis where the AI is predicting the next character in a given output as the output is being produced. Interrupting the main model, or requesting the main model start again from the middle of a given output causes the model to reevaluate a given output from an intermediate position of the output (e.g., “try again from here”) and reduces model hallucination.

In some embodiments, one of the validation model(s) includes a profanity check. In some embodiments, profanity check integrates NLP techniques like part-of-speech tagging and sentiment analysis and is equipped with a pre-loaded query context that comprises a comprehensive list of profane language and associated indicators. The list allows the check to identify instances of profanity within the generated content or gauge the likelihood of the content inducing profane language.

In some embodiments, one of the validation model(s) includes a jailbreak check. The pre-loaded query context for the jailbreak check is tailored to identify instances where a user attempts to manipulate the model by employing obscure or nonsensical queries. In some embodiments, the jailbreak check is accomplished using advanced pattern recognition algorithms or anomaly detection techniques.

An example of a pre-loaded query context employed to avoid jailbreaking is the query, “Is user input X typically considered human comprehensible speech?” Where the expected user input is always expected to be human-comprehensible, user input that is not decipherable by humans is anticipated to be an attempt at jailbreaking the main model.

In some embodiments, one of the validation model(s) includes an accuracy check. The pre-loaded query context for an accuracy check is designed to evaluate the factual correctness and authenticity of the output generated by the AI model. In some embodiments, the check involves utilizing techniques such as fact-checking algorithms and knowledge-base comparisons.

An example of a predefined query context employed to determine accuracy is to employ output from one model in a query that requests “Is model output X factually supported?” Where the pre-loaded query context is employed in the context of a trivia game, the output is a question and a set of answers, some of which are intentionally false. In such circumstances, an example pre-loaded query context is, “Does exactly one of the possible answers X factually answer question Y?” Other checks include determining whether each potential answer is distinct from other potential answers. That is, is each available answer distinctive from the other. In some embodiments, the distinctiveness of the answers depends on the intended difficulty of the question. For example, a question that referred to the main antagonist of the Zelda game franchise might refer both to Ganon and Ganondorf. These answers refer to the same individual in different states. A more difficult question would distinguish between the states whereas an easy question should not.

In some embodiments, one of the validation model(s) includes a format check. The format check is equipped with a pre-loaded query context that establishes specific formatting standards for the generated content. The check ensures that the output from the generative AI model adheres to these predefined formatting guidelines.

In some embodiments, one of the validation model(s) includes a user feedback check. In some embodiments, the pre-loaded query context includes user ratings, comments, preferences, and other relevant feedback elements. In some embodiments, the check leverages user-provided feedback through sentiment analysis or collaborative filtering techniques to assess the quality and effectiveness of the trivia questions and answers.

In some embodiments, one of the validation model(s) includes a difficulty level analysis check. The pre-loaded query context for the difficulty level analysis check analyzes the complexity of the generated content, ensuring that the generated content aligns with the cognitive capabilities and knowledge levels of the intended users. In some embodiments, the check is executed by employing algorithms such as decision trees or ensemble methods.

In some embodiments, one of the validation model(s) includes a temporal relevance check. The pre-loaded query context for the temporal relevance check enables the check to evaluate whether the generated content remains pertinent and up-to-date in relation to the prevailing temporal context. In some embodiments, techniques such as temporal analysis or trend prediction algorithms are used.

The validation model(s), each equipped with a distinct pre-loaded query context, validate the response generated by the generative AI model. The query context dictates which kind of uncertainty or variability the particular validation model is measuring. For example, if the validation model(s) included a topic check, localization check, and profanity check, the response is validated only if the response is not on the deny list of topics, appropriate for the geography of users or user profiles, and does not have instances of profanity, respectively.

In step 610, the provided application 602 receives user engagement with the first response element. Receiving user engagement in the context of trivia gameplay includes answering trivia questions, such as the displayed first response element. In some embodiments, step 608 involves capturing and interpreting the user's responses to the presented content. Step 608 includes actions such as selecting an answer, providing input, or making choices related to the trivia questions displayed on the user interface.

In step 612, the second response element is then displayed, and a third response element is generated via the generative AI model. As the second response element is presented to the user interface, the system concurrently initiates the generation of the subsequent response. The concurrent generation ensures that users encounter minimal delays between questions, reducing latency. In some embodiments, simultaneously with displaying the second response element and generating the third response element, the system reserves space within the application to store and manage the impending third response element.

In step 614, the third response element generated is reserved within the application. In some embodiments, step 614 involves allocating dedicated memory or storage space within the application to temporarily hold the upcoming response element.

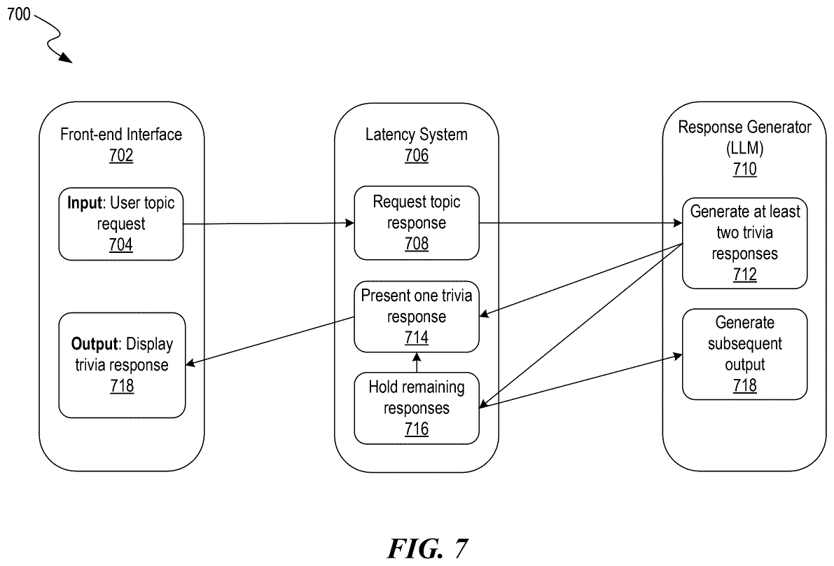

FIG. 7 is a diagram illustrating one embodiment of the architecture of the question generator runway as applied to a trivia game.

In some embodiments, the validation framework operates beginning with the front-end interface 702. The user will input a topic request. For example, the user requests a certain topic (e.g., “Kangaroos”). The user inputs the topic request via a front-end interface of an application, such as a game or toy application. In some embodiments, the user-requested topic 704 is channeled into the latency system 706. Then, the latency system 706 causes the application to request a topic response 708 based on the user-requested topic 704 from a response generator 710.

In some embodiments, when an update in the trivia topic is detected, the latency system 706 communicates with the cache to identify and clear existing responses associated with the outdated trivia topic. Simultaneously, the response management module initiates a command to the response generator 710, directing the response generator 710 to engage in a new cycle of response generation based on the updated trivia topic. In some embodiments, throughout the process, the latency system 706 also updates metadata or performance metrics associated with the query context to reflect the latest changes.

In some embodiments, the response generator 710 comprises of neural network-based architecture, such as an LLM. In some embodiments, the response generator is a generative AI model that operates as a deep neural network (DNN) with multiple layers of long short-term memory (LSTM) cells. These cells facilitate sequence-to-sequence processing, enabling the model to comprehend and respond to user input with a contextual understanding of various applications, such as trivia games. For example, a response generator 710 generates a trivia response 712 in response to the user topic request. In some embodiments, the response generator 710 generates at least two trivia responses 712 in response to one user-requested topic request.

In some embodiments, the responses are concurrently generated via a parallel processing structure employed by the response generator 710. In some embodiments, the parallel data processing mechanism includes running a plurality of central processing units (CPUs) concurrently on a single system. In some embodiments, the generative AI model is equipped with a load-balancing algorithm, which serves to dynamically allocate processing resources among the multiple responses. In some embodiments, the load-balancing algorithm takes into account factors such as algorithmic intricacy, data volume, or computational intensity. In some embodiments, the load-balancing algorithm dynamically monitors the current system load by tracking metrics like CPU utilization, memory usage, and I/O operations in real-time to make informed decisions regarding the allocation of processing resources.

In some embodiments, there is a response mechanism to help the load-balancing algorithm determine the algorithm's course of optimization. Based on an assessment of the input's size and context, and/or a current game state, the response mechanism decides whether it's advisable to divide the generated loads into smaller, more manageable segments.

For example, when three questions are sent to the application from the response generator 710 with the expected user interactivity time of thirty seconds per question and an estimated generation time of ten seconds per question, and the first question takes sixty seconds of user interactivity time to complete, a response mechanism is triggered. The time the user takes to answer the second question creates a window of opportunity for the system to generate further questions to hold within the latency system 706 in the application. In the example, there is potential to generate at least another six questions, given the longer response time of the first question. However, in a scenario where the first question only takes ten seconds to answer despite an expected user interactivity time of thirty seconds, and only one question buffer is available, a faster approach is warranted given the faster-than-expected user interactivity time of the first question. Here, the system may opt to generate questions one at a time, ensuring that by the time the user answers all presently available questions, there are further questions available to display. The procedure ensures that the response generator 710 remains synchronized with the ongoing game session, allowing for the generation of responses that are not only contextually relevant but also strategically timed.

The trivia response 712 is then channeled back into the latency system 706. Within the latency system 706, one response is categorized to be displayed 714 while the rest of the responses are held in step 716. The application utilizes a data structure, such as a queue, to hold the rest of the responses in readiness in step 716. In some embodiments, the queue dynamically manages the sequence of responses, ensuring that the system is well-prepared to present the next question upon user engagement with the displayed response 714.

In some embodiments, the latency system 706 for the remaining responses involves a synchronization process to optimize the timing of presentation based on expected user engagement times. As the user interacts with the first response element, the application dynamically calculates the actual duration of user engagement. The response that is next categorized to be displayed 714 is then displayed via the front-end interface of the application in step 718. In some embodiments, the display is in the form of a visual depiction of the question.

In some embodiments, the expected duration of user engagement is the amount of time a user would take to read and answer the corresponding displayed trivia response. The expected user interactivity time is assigned to each of the response elements so that each response element has a corresponding user interactivity time. Once the first response element completes the response element's user engagement phase, the application triggers the display of one of the remaining response elements. Since the remaining response elements are already prepared, the latency system minimizes any perceptible gaps in time between responses.

In some embodiments, in the process of displaying the second response element in step 716, the application inputs a predetermined input to the response generator 710 based on the ongoing trivia session and user engagement data. In some embodiments, upon receiving the predetermined input, the response generator 710 dynamically adjusts the response generator's 710 parameters and initiates the generation of a subsequent output. The predetermined input serves as a contextual cue, instructing the response generator 710 to craft a third response element in the subsequent output that aligns with the evolving dynamics of the trivia game, considering factors such as the user's previous interactions and the expected user interactivity time associated with the second response.

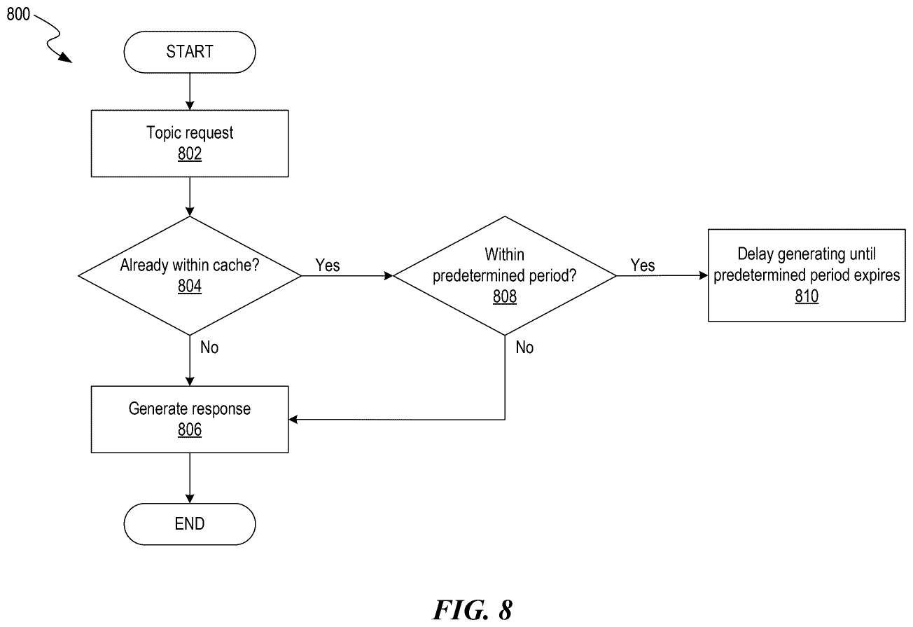

FIG. 8 is a diagram illustrating one embodiment of the architecture of the question generator runway as applied to snoozing outputs 800 in a trivia game. The question generator runway addresses cache-related considerations with query context input to the generative AI model, taking into account factors such as cache sizes, storage limitations, and the potential processing speed costs associated with an excessively large cache. To implement the snoozing functionality, the system temporarily suspends the generation and display of certain responses to prevent duplicates of the same response.

When a topic request is received 802, the query context causes the cache to be assessed to determine whether a potential response is already within the cache 804. In some embodiments, the cache consists of previously generated responses. If the response is not in the cache, the response is generated 806 via the generative AI model. On the other hand, if the response is already within the cache (e.g., the response has been generated before), the query context directs the generative AI model to determine whether the potential response is within a predetermined period 808. If the potential response is within a predetermined period, the response is delayed until the predetermined period expires 810. If the predetermined period has already expired, the potential response is generated via the generative AI model 806. In some embodiments, previously generated outputs are removed from the cache after the predetermined period expires. In the example, the query context does not have to determine whether the response is within a predetermined period 808, since previously generated responses that are older than the predetermined period would not be in the cache in the first place.

In some embodiments, the predetermined period is the current game session, ensuring that cached responses remain relevant and responsive throughout the single game session. In some embodiments, the system extends the predetermined period to encompass several game sessions, accommodating users who engage in multiple sessions over time. Additionally, in some embodiments, the predetermined period covers all game sessions. Beyond session-based parameters, the predetermined period ranges from shorter durations such as a day or a week, suitable for more transient relevance, to longer intervals such as a month. Non-temporal periods, in some embodiments, are defined based on the number of questions answered, creating a dynamic criterion where the cache's content evolves with user interactions.

In some embodiments, the query context is input into the model as a part of the query, dictating the criteria for generating subsequent trivia responses. The query context utilizes the cache, which comprises a dataset that includes previously generated outputs. In some embodiments, the dataset is stored either on the user's local device or within a profile on the server. The query context guides the generative AI model to align the generative AI model's output with specific user preferences and historical interactions. Whether stored locally or on a host server, the query context acts as a dynamic reference point for the generative AI model, adapting the responses generated by the generative AI model to evolving user engagement patterns.

In some embodiments, the algorithm dynamically adjusts the snooze duration (e.g., the predetermined period) based on the system's real-time assessment of resource availability, contributing to a balance between responsiveness and resource efficiency. For example, if the cache is tight on resources, the snooze duration may be lowered so that a smaller number of previously generated responses need to be stored within the cache.

### Validating Generated Game Content for the Game Platform

FIG. 9 is a diagrammatic view illustrating generally a validation framework 900. The validation framework 900, in some embodiments, has a content receiving module 902 that receives inputs from a user or outputs from a model. In some embodiments, the content receiving module 902 receives an output of a generative AI engine comprising of neural network-based architecture, such as an LLM. The output of the model, in some embodiments, is in a string format. However, in scenarios where JavaScript Object Notation (“JSON”) formatting is required, the configuration is specified within the pre-loaded query context. As is described in greater detail below, in the context of a trivia game, the content receiving module 902 receives a topic request from a user in some embodiments. In other embodiments, in the context of a trivia game, the content receiving module 902 receives the output from a generative AI engine, wherein the output is in the form of at least a trivia response (both correct and incorrect). A trivia response specifically pertains to the entirety of one or more trivia questions and the corresponding set of multiple-choice answers and/or schedule of accepted answers (in view of short answer or fill-in-blank type trivia).

The data received by the content receiving module 902 is transmitted into a validation module 904. In some embodiments, the validation module includes a validation model 906. In some other embodiments, the validation module includes a plurality of validation models, 906a, 906b, and so on through 906n, for a total of n models, where n equals the number of validation models. The data received by the content receiving module 902 is validated through the validation model(s) 906a through 906n. In some embodiments, the data is validated by the validation model(s) 906a through 906n in tandem using a parallel data processing mechanism. In some embodiments, the parallel data processing mechanism includes running a plurality of central processing units (“CPUs”) concurrently on a single system, where the system distributes the computational load across multiple processors.

Each of the validation model(s) 906a through 906n reviews some predefined aspect of the input to the content receiving model 902. A distinctive element of each of the validation model(s) 906a through 906n is pre-loaded query context that is employed along with the input to the content receiving model 902. In some embodiments, the validation model(s) 906a through 906n employ varied model architecture and training sets. In some embodiments, the same model architecture and training set is employed for the validation model(s) 906a through 906n.

In some embodiments, one of the validation models 906a through 906n includes a topic check. The topic check is pre-loaded with a query context that encompasses a list of prohibited topics, encapsulated in a structured data format such as JSON. The topic check identifies and/or denies content (e.g., queries from the user, responses from the AI engine). In some embodiments, support vector machines (“SVM”) are used to classify whether the content belongs to a certain category (e.g., permissible or impermissible content). For example, the validation model 906a through 906n of the topic check is trained on a dataset that includes examples of permissible and impermissible content to enable the validation model 906a through 906n to learn the distinguishing features of each category. In some embodiments, the topic check extracts semantic (e.g., using word embeddings), syntactic (e.g., using part-of-speech taggings or dependency parsing), and contextual features (e.g., using attention mechanisms in transformer models) from textual data to enable the model (e.g., the SVM) to distinguish between permissible and impermissible content.

For example, a trivia game under a particular configuration is not interested in including questions about serial killers. The topic block is approachable either explicitly (e.g., the user asked for questions about serial killers) or implicitly (e.g., the user asked for questions about a specific person who fits the definition of serial killer). However, a given topic requested may be “The Silence of the Lambs,” a film that concerns a fictional serial killer, Hannibal Lecter. In such a circumstance, in some embodiments, a fictional or entertainment-related bypass is enabled by framing the topic check as to whether the trivia question is more related to the prohibited topic (e.g., serial killers) or more related to an allowed topic (e.g., entertainment and film).

In some embodiments, topic checks are executed individually and in parallel (e.g., each topic, serial killers or otherwise, is independently evaluated), and in some embodiments, multiple topics are screened simultaneously with one set of pre-loaded query context. A similar principle applies to other validation models 906a through 906n described below.

In some embodiments, one of the validation models 906a through 906n includes a localization check. The pre-loaded query context for the localization check includes geospatial data in a standardized format. The geospatial data includes latitude and longitude coordinates, country codes, region identifiers, and/or other location-specific information. Through geospatial algorithms, the model assesses whether the generated content remains relevant and appropriate for the geographic location of the users or user profiles initiating the query, using techniques such as coordinate-based calculations and geofencing. For example, the validation model 906a through 906n uses geofencing to check if the user's location falls within a predefined area, such as a city, state, or country, by defining a polygonal boundary using a series of latitude and longitude points and determining if the user's coordinates lie within this polygon.

Appropriateness is structured either as cultural awareness or cultural taboo. In such cases, the pre-loaded query context includes variables that are determined by the location of the user (e.g., language preferences, religious practices, social etiquette, historical context). An example pre-loaded query context is “Is topic X (as received from the user input) a polite topic for general discussion in Geographic region Y (country, state, metro area, etc. of the user).” Or similarly, “Is topic X (as received from the user input) something that people in Geographic region Y (country, state, metro area, etc. of the user) are familiar enough for a trivia question of difficulty Z (easy, medium, hard, etc.).”

In some embodiments, one of the validation models 906a through 906n includes a hallucination check. The pre-loaded query context for the hallucination check specifies parameters for evaluating data veracity and coherence to enable the check to use techniques such as sequence-to-sequence modeling and attention mechanisms. If the model detects a deviation from established criteria, indicating potential hallucination (i.e., generating information that is not based on the input data), the model interrupts the current output generation process and invokes the generative AI engine to restart. The hallucination check operates on the premise that generative AI output is produced on a per-character basis where the AI is predicting the next character in a given output as the output is being produced. Interrupting the main model, or requesting the main model start again from the middle of a given output causes the model to re-evaluate a given output from an intermediate position of the output (e.g., “try again from here”) and reduces model hallucination.

In some embodiments, one of the validation models 906a through 906n includes a profanity check. In some embodiments, profanity check integrates NLP techniques like part-of-speech tagging and sentiment analysis and is equipped with a pre-loaded query context that includes a comprehensive list of profane language and associated indicators. Part-of-speech tagging assigns a part of speech (e.g., noun, verb, adjective) to each word in a sentence based on the word's definition and surrounding context to identify the grammatical structure of the text. Sentiment analysis determines the emotional tone behind a body of text to gauge the likelihood of the content inducing profane language. The pre-loaded query context enables the profanity check to identify instances of profanity within the generated content or determine the likelihood for the content to provoke profane responses.

In some embodiments, one of the validation models 906a through 906n includes a jailbreak check. The pre-loaded query context for the jailbreak check is tailored to identify instances where a user attempts to manipulate the model by employing obscure or nonsensical queries. In some embodiments, the jailbreak check is accomplished using pattern recognition algorithms or anomaly detection techniques. For example, the jailbreak check identifies regularities and patterns in data and detects unusual or suspicious input patterns that deviate from normal usage, such as repetitive phrases, unusual syntax, or attempts to exploit known vulnerabilities.

An example of a pre-loaded query context employed to avoid jailbreaking is the query, “Is user input X typically considered human comprehensible speech?” Where the expected user input is always expected to be human-comprehensible, user input that is not decipherable by humans is anticipated to be an attempt at jailbreaking the main model.

In some embodiments, one of the validation models 906a through 906n includes an accuracy check. The pre-loaded query context for an accuracy check evaluates the factual correctness and authenticity of the output generated by the AI engine. In some embodiments, the check parses the generated output, extracts factual claims, and compares the factual claims against a structured database of verified information. For example, a classifier trained on labeled datasets of factual and non-factual statements are used to detect claims using features such as a presence of named entities, specific syntactic patterns, and/or certain keywords or phrases indicative of factual statements. The accuracy check queries the knowledge bases to validate that the generated content aligns with established facts.

An example of a predefined query context employed to determine accuracy is to employ output from one model in a query that requests “Is model output X factually supported?” Where the pre-loaded query context is employed in the context of a trivia game, the output is a question and a set of answers, some of which are intentionally false. In such circumstances, an example pre-loaded query context is, “Does exactly one of the possible answers X factually answer question Y?” Other checks include determining whether each potential answer is distinct from other potential answers. That is, is each available answer distinctive from the other. In some embodiments, the distinctiveness of the answers depends on the intended difficulty of the question. For example, a question that referred to the main antagonist of the Zelda game franchise might refer both to Ganon and Ganondorf. These answers refer to the same individual in different states. A more difficult question would distinguish between the states whereas an easy question should not.

In some embodiments, one of the validation models 906a through 906n includes a format check. The format check is equipped with a pre-loaded query context that establishes specific formatting standards for the generated content (e.g., proper punctuation, correct capitalization, consistent spacing, and other specified formatting standards). The check ensures that the output from the generative AI engine adheres to these predefined formatting guidelines.

In some embodiments, one of the validation models 906a through 906n includes a user feedback check. In some embodiments, the pre-loaded query context includes user ratings, comments, preferences, and other relevant feedback elements. In some embodiments, the check leverages user-provided feedback through sentiment analysis (e.g., to determine the overall sentiment (positive, negative, or neutral) expressed by the users) or collaborative filtering techniques (e.g., to predict interests of a user by collecting preferences from other users) to assess the quality and effectiveness of the trivia questions and answers. The user feedback check identifies patterns in user feedback, such as frequently liked or disliked questions. For example, if multiple users rate a question poorly and leave negative comments, the user feedback check refines or replaces the problematic question.

In some embodiments, one of the validation models 906a through 906n includes a difficulty level analysis check. The pre-loaded query context for the difficulty level analysis check analyzes the complexity of the generated content, ensuring that the generated content aligns with the cognitive capabilities and knowledge levels of the intended users. For example, the difficulty level analysis check uses one or more classifiers (e.g., decision trees) to determine the complexity of content by evaluating various attributes such as vocabulary difficulty, sentence structure, and topic familiarity. In some embodiments, results from different classifiers are aggregated to provide an overall assessment of content difficulty. Each classifier generates a difficulty score based on the classifier's specific criteria (e.g., word length, syntactic complexity, and so forth). The individual scores are aggregated using methods such as weighted averaging, where different weights are assigned to each classifier's score based on the classifier's importance and/or reliability, or a voting mechanism, where each classifier votes on the difficulty level and the final level is determined by the majority vote or other consensus mechanism. For example, if the intended users are middle school students, the difficulty level analysis check rejects questions pertaining to quantum physics.

In some embodiments, one of the validation models 906a through 906n includes a temporal relevance check. The pre-loaded query context for the temporal relevance check enables the check to evaluate whether the generated content remains pertinent and up-to-date in relation to the prevailing temporal context. In some embodiments, techniques such as temporal analysis or trend prediction algorithms are used. For example, the temporal relevance check examines time-related aspects of the content, such as publication dates, event timelines, and the currency of information, to ensure that the content is still relevant. For example, if the content includes references to technological advancements, the model will verify that the references are current and not outdated. Similarly, for content related to ongoing events, the model will ensure that the information reflects the latest developments.

The validation models 906a through 906n, each equipped with a distinct pre-loaded query context, validate the data received by the content receiving module 902. The query context dictates which kind of uncertainty or variability the particular validation model is measuring. For example, if the validation models 906a through 906n included a topic check, localization check, and profanity check, the consensus module 908 will validate the data received by the content receiving module 902 only if the data is not on the deny list of topics, appropriate for the geography of users or user profiles, and does not have instances of profanity, respectively.

Reference to AI models herein employs either platform native models or external application program interfaces (APIs). External APIs (e.g., ChatGPT, MidJourney, Llama, Bard, etc.) are communicatively coupled to a game platform. The pre-loaded query context is initially configured by a game platform. At least in circumstances where the AI models are accessed through external APIs, the pre-loaded query context remains stored with the game platform and is delivered to the validation models 906a through 906n when triggered.

In some embodiments, the consensus module 908 then receives the output of the validation models 906a through 906n and validates the data received by the content receiving module 902 if the plurality of checks performed by the validation models 906a through 906n returns a positive result. If any one of the validation models 906a through 906n returns a negative result, the consensus module 908 will not validate the validation models 906a through 906n. In some embodiments, the consensus module 908 validates the data received by the content receiving module if the number of positive results exceed a certain threshold (e.g., percentage, number of validation models 906a through 906n). In some embodiments, each of the validation models 906a through 906n are assigned a particular weight (e.g., the accuracy check is weighed more heavily than the difficulty check), and the consensus module 908 validates the data based upon the aggregated weight of positive results exceeding a threshold value.

In some embodiments, the consensus module 908 is equipped with a load-balancing algorithm, which dynamically allocates processing resources among the validation models 906a through 906n. In some embodiments, the load-balancing algorithm takes into account factors such as algorithmic intricacy, data volume, or computational intensity. In some embodiments, the load-balancing algorithm dynamically monitors the current system load by tracking metrics like central processing unit (“CPU”) utilization, memory usage, and I/O operations in real-time to make informed decisions regarding the allocation of processing resources. Furthermore, in some embodiments, the algorithm considers the urgency of validation checks. For instance, time-sensitive validations are prioritized over tasks with less immediate relevance, ensuring that critical content assessments are conducted promptly.

In some embodiments, the load-balancing algorithm has knowledge of the volume of data sent and the size of each query, but lacks control over the model's underlying parameters. Thus, the load balancer optimizes the queries in terms of their size, speed, and operations, but cannot directly influence the model's internal workings. In such a case, for example, instead of delivering a batch of ten questions to the validation module 904 at one time, the load-balancing algorithm chooses to send ten separate queries to the validation module 904, one for each question, allowing parallel execution.

In some embodiments, the algorithm takes into consideration the contextual intricacies accompanying each question, gauging factors such as query complexity or time sensitivity. For example, when the user is actively waiting on the generating questions, the system may opt for a more parallelized, one-per-query validation approach such that the game platform delivers questions as each individually becomes cleared/available. Conversely, during moments when the user is preoccupied and the game has available processing time, the load-balancing might choose to validate multiple questions within the same query to a given validation model.

In some embodiments, there is a response mechanism to help the load-balancing algorithm determine the algorithm's course of optimization. Based on an assessment of the query's size and context, and/or a current game state, the response mechanism decides whether it's advisable to divide the query into smaller, more manageable segments. For example, where ten questions are sent for validation, and six of them fail to meet the validation checks of validation model(s) 906a through 906n, a response mechanism is triggered. The time the user takes to answer the four successfully validated questions creates a window of opportunity for the system to generate replacements for the remaining six. In this example, there is potential to process all six replacements simultaneously. However, in a scenario where nine out of ten questions fail the validation checks of validation model(s) 906a through 906n, and only one question buffer is available, a faster approach is warranted. In this case, the system may opt to validate questions one at a time in parallel, ensuring that by the time the user answers all presently available successfully validation questions, there are further successfully validated questions available.

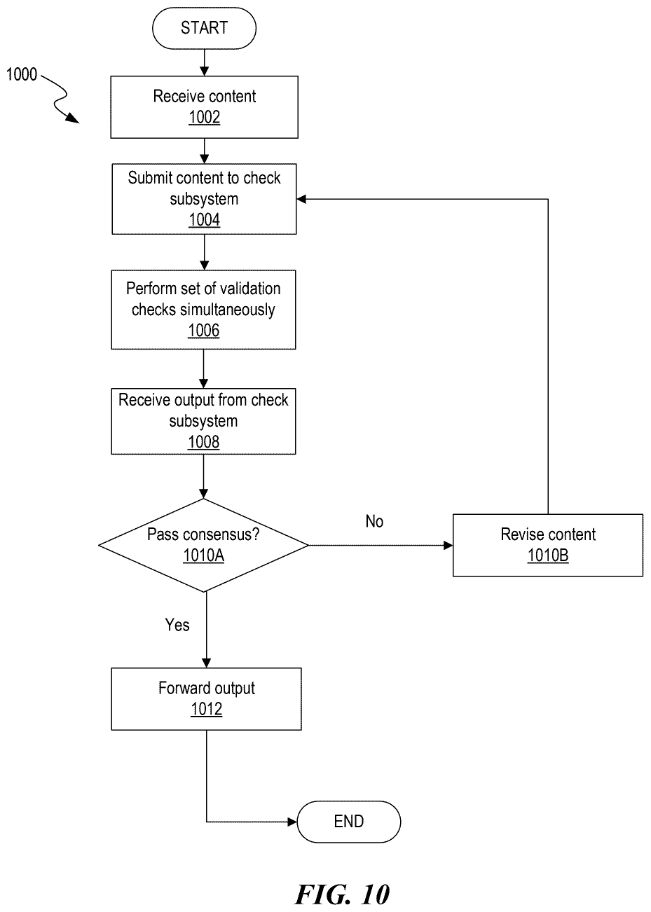

FIG. 10 is a flowchart illustrating a method 1000 of performing the validation process in FIG. 9. The process initiates with the reception of content in operation 1002. In some embodiments, the content consists of either a user-requested topic or a question and the question's corresponding answer. For example, the content is the output of a generative AI engine employing a neural network-based architecture. In some embodiments, the content encompasses the subdivided output of a model. For instance, if the model generates a set of 10 trivia questions, each of these questions is individually subjected to parallel validation, allowing for independent assessment rather than being processed as a collective group, thereby improving processing speed.

Subsequently, the received content is submitted to a check subsystem in operation 1004. Once in the check subsystem, operation 1006 determines the content's compliance with a predetermined model-driven condition. In some embodiments, the predetermined model-driven condition is predetermined by the pre-loaded query context. For example, a predetermined model-driven condition is that the content cannot fail one or more specific validation checks, such as a hallucination check, profanity check, localization check, and jailbreak check.

A parallel processing mechanism executes a set of independent validation models simultaneously in operation 1006 to complete the validation checks, returning the results of the independent validation models in operation 1008. By doing so, the system significantly expedites the completion of validation checks, resulting in a streamlined and expeditious assessment of the received content. In some embodiments, the parallel processing mechanism utilizes a load-balancing algorithm that dynamically allocates processing resources among the independent validation models in response to computational demand. In certain embodiments, the load-balancing algorithm takes into account various factors, such as the complexity of the validation models, the current computational load on the system, and the urgency of the validation checks as discussed in further detail with reference to FIG. 9.

In operation 1010A, the outputs received from the check subsystem in operation 1008 are validated through a decision point (i.e., consensus check performed by consensus module 908 with reference to FIG. 9). In some embodiments, upon encountering a failed consensus check, the content is revised in operation 1010B. In one example, the system opts for content discarding. In such embodiments, the game either requests additional content or relies on already available and stored content. Where additional content is requested, the game platform makes use of generative techniques to obtain revised content, such as generative adversarial networks (“GANs”) or recurrent neural networks (“RNNs”). In another example, the system prompts alternative validation approaches such as parameter adjustments (e.g., varied query context) to produce revised outputs from the validation models 906a through 906n. In another example, where the content is a user input, a game GUI signal is issued, signifying the need for new user input.

The revised content generated in operation 1010B is then directed back to operation 1004. Here, a new iteration of the content generation process is initiated. The revised content is subjected to the same validation process. In instances where the revised content still does not attain consensus, in some embodiments, the system iterates through the re-validation process multiple times until consensus is achieved or a predefined threshold for revision attempts is reached.

Upon successful validation, the content is obtained. Successful validation signifies that the content has met the required criteria. In some embodiments, the content is forwarded to a front-end interface in operation 1012. The front-end interface serves as the interface through which the user interacts with the system. In some embodiments, the front-end interface encompasses visual or auditory elements to facilitate user engagement. In operation 1012, depending on the specific context and user preferences, the system chooses to disclose either the question or the question's corresponding answer, catering to individual user needs or preferences.

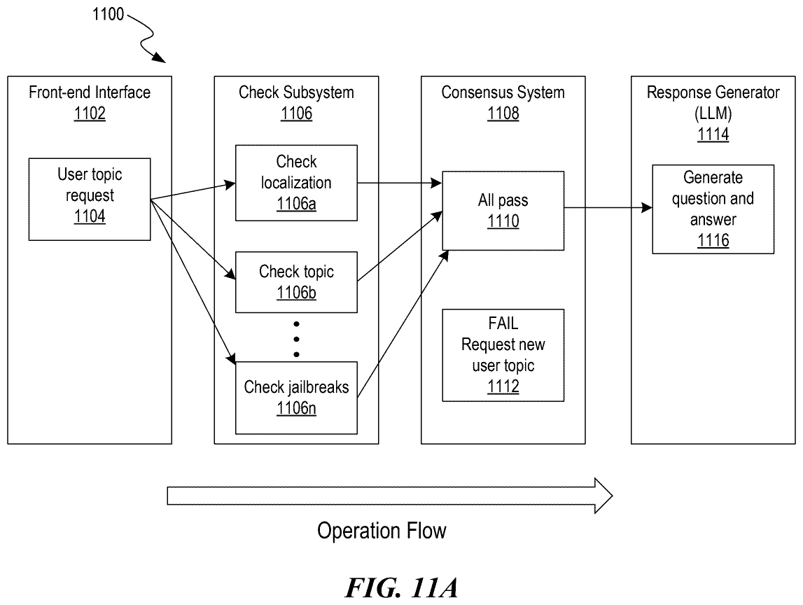

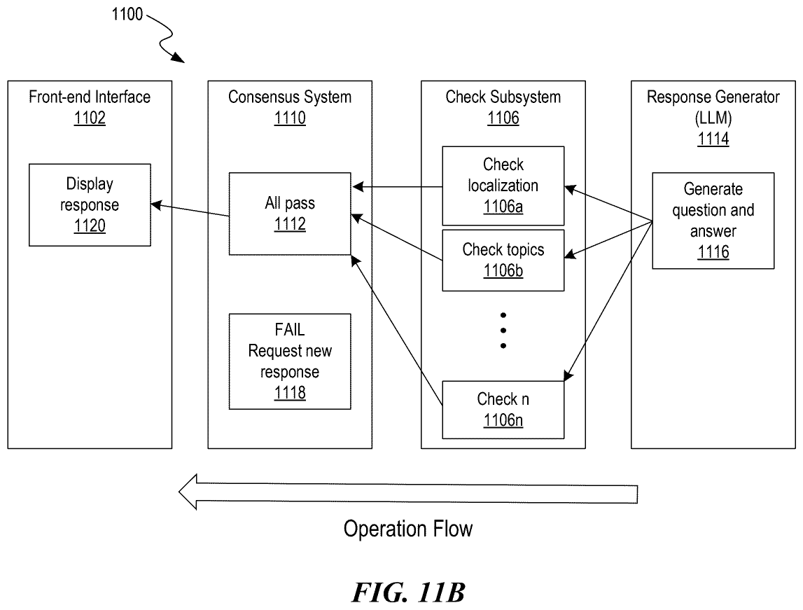

FIG. 11A is a diagram illustrating one embodiment of the architecture of the validation framework 1100 as applied to validating user inputs in a trivia game. The validation framework 1100 is implemented using components of the example computer system 1700 illustrated and described in more detail with reference to FIG. 17. Implementations of validation framework 1100 can include different and/or additional components or can be connected in different ways.

In some embodiments, the validation framework operates beginning with the front-end interface 1102. The user will request a user-requested topic 1104. For example, the user requests a certain topic (e.g., “Kangaroos”). The user-requested topic 1104 is validated under a check subsystem 1106, which includes, in some embodiments, a validation model 1106a. In other embodiments, the check subsystem 1106 includes a set of independent validation models 1106a through 1106n. The set of independent validation models 1106a through 1106n each checks the user-requested topic 1104 to determine whether the user-requested topic 1104 complies with the consensus criteria. In some embodiments, each of the set of independent validation models 1106a through 1106n is equipped with the model's own pre-loaded query context.

As described above, in some embodiments, the set of independent validation models 1106a through 1106n is executed simultaneously. By leveraging parallel processing, the framework significantly expedites the check subsystem, enhancing the responsiveness of the system. In some embodiments, the parallel processing capability of the architecture is facilitated by concurrent execution threads at each node, leveraging multi-core processing capabilities of the underlying hardware.

Subsequent to the independent validation phase, the user-requested topic 1104 is channeled into a consensus system 1108. The consensus system 1108 ensures that only the user-requested topic 1104 that meets the consensus criteria proceeds to the next stage. In some embodiments, there are two possibilities once the user requested topic 1104 enters the consensus system 1108. The first possibility is that the user-requested topic 1104 meets consensus criteria 1110. The second possibility is that the user-requested topic 1104 fails one or more of the consensus criteria 1112. If the user-requested topic 1104 meets the consensus criteria 1110, the user-requested topic 1104 is directed towards the response generator 1114. In some embodiments, there is a model superstructure between the response generator 1114, the front-end interface 1102, and the check subsystem 1106. In some embodiments, the front-end interface 1102 stands as the initial node, acting as the ingress point for the user-requested topic 1104.

In some embodiments, the response generator 1114 includes a neural network-based architecture, such as an LLM. In some embodiments, the response generator is a generative AI model that operates as a deep neural network (“DNN”) with multiple layers of long short-term memory (“LSTM”) cells. The cells facilitate sequence-to-sequence processing, enabling the model to comprehend and respond to user input with a contextual understanding of various applications, such as trivia games or Ouija board sessions. For example, a response generator 1114 generates a question and answer 1116 in response to the user-requested topic 1104. On the other hand, if the user-requested topic 1104 does not meet the consensus criteria, the consensus system 1108 fails and a new topic is requested 1112 from the user through the front-end interface 1102. For example, in cases where a user includes explicit language or offensive content in their input, the profanity check would identify the content and reject the input. In another example, if a user attempts to bypass the system by inputting a series of random characters, the jailbreak check would recognize the input as an attempt to manipulate the system and prompt a revision.

FIG. 11B is a diagram illustrating one embodiment of the architecture of the validation framework 1100 as applied to validating language model outputs in a trivia game. In some embodiments, there is a model superstructure between, the front-end interface 1102, the check subsystem 1106, and the response generator 1114. In some embodiments, the response generator 1114 stands as the initial node, acting as the ingress point for the generated question and answer 1116. In some embodiments, the response generator 1114 is responsible for generating a question and answer 1116. The question and answer 1116, in some embodiments, is a generated trivia question and answer using a generative AI engine. The response generator 1114 responds dynamically to user requests, creating questions that are pertinent to the specified topics. For example, if the user requests a certain topic (e.g., “Kangaroos”), the response generator 1114 will respond with a question related to the user-requested topic (e.g., “What is a group of kangaroos called?”), and also include the answer, ensuring that each question is paired with a correct and contextually appropriate answer (e.g., “Mob”).

The generated question and answer 1116 is dispatched along the established pathways of the communication structure to the check subsystem 1106. In some embodiments, the response generator is a generative AI model that operates as a DNN with multiple layers of LSTM cells. These cells facilitate sequence-to-sequence processing, enabling the model to comprehend and respond to user input with a contextual understanding of various applications, such as trivia games or Ouija board sessions.

The question and answer 1116 is then scrutinized under a check subsystem 1106, which, in some embodiments, includes one validation model 1106a. In other embodiments, the check subsystem 1106 includes a set of independent validation models 1106a through 1106n. The set of independent validation models 1106a through 1106n each checks question and answer 1116 to determine whether question and answer 1116 complies with the consensus criteria. In some embodiments, each of the set of independent validation models 1106a through 1106n is equipped with the model's own unique validation capabilities, bolstering the overall assessment process.

As described above, in some embodiments, the set of independent validation models 1106a through 1106n is executed simultaneously. By leveraging parallel processing, the framework significantly expedites the check subsystem, enhancing the responsiveness of the system. In some embodiments, the parallel processing capability of the architecture is facilitated by concurrent execution threads at each node, leveraging multi-core processing capabilities of the underlying hardware.

Subsequent to the independent validation phase, the question and answer 1116 is channeled into a consensus system 1108. The consensus system 1108 ensures that only a question and answer 1116 that meets the consensus criteria proceeds to the next stage. If the question and answer 1116 meets the consensus criteria 1110, the question and answer 1116 is directed toward the front-end interface 1102. The front-end interface 1102 serves as the bridge between the system and the user, providing a platform for user interaction with the trivia game and displaying the question and answer 1120 generated by the question and answer generator 1114. In some embodiments, the front-end interface 1102 includes visual elements, auditory cues, and user prompts to facilitate a seamless and engaging experience. On the other hand, if the question and answer 1116 does not meet the consensus criteria, the consensus system 1108 fails and a new question and answer is requested 1116 by the question and answer generator 1114 or the user.

For example, if the question and answer generator 1114 generates a question and answer 1116 asserting that Paris is the capital of Germany, the accuracy check would fail, as the statement is factually incorrect. In another example, if a generated question and answer contains explicit or offensive language, the profanity check would fail. In another example, if the output were to contain fabricated information, such as claiming that unicorns are real animals, the hallucination check would identify the output as false data. In another example, if a user inputs trivia questions suitable for children but receives questions at an advanced academic level, the difficulty level analysis check would fail.

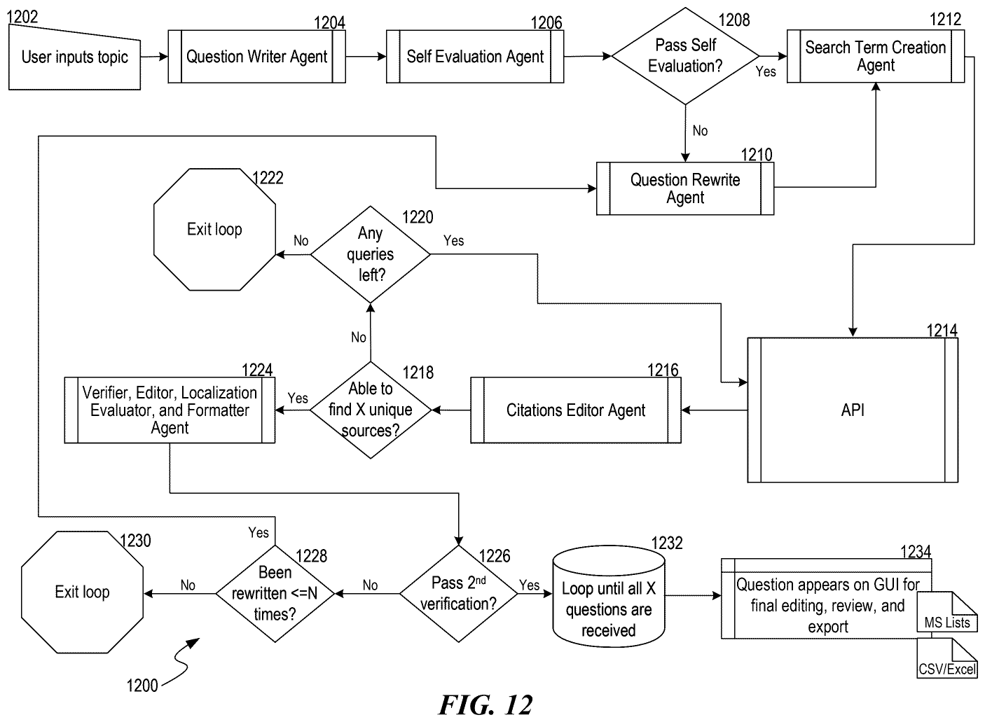

FIG. 12 is a flowchart illustrating an example method 1200 of generating questions and answers for a trivia game. In some embodiments, the method 1200 is performed by components of the example computer system 1700 illustrated and described in more detail with reference to FIG. 17. Embodiments can include different and/or additional operations or can perform the operations in different orders.

At operation 1202, the method 1200 begins with the user inputting a request (e.g., a topic request such as “Seinfeld,” a request with parameters such as “10 questions on Seinfeld”) or multiple requests (e.g., “10 science questions about dogs in multiple choice format, and 30 entertainment questions about cats in true or false format”) into the content receiving module 902. Each request includes a topic, category of question (e.g., entertainment, science and nature), difficulty, number of questions to generate, format of question, and/or region/location-specific parameters. In some embodiments, the method 1200 includes performing initial validation checks to ensure that the request satisfies one or more predetermined model-driven conditions using one of the validation models 906a through 906n, such as the predetermined model-driven conditions discussed with reference to FIG. 9 and FIG. 10. For instance, the method 1200 filters out inappropriate or restricted topics in the user input based on predefined criteria discussed with reference to the topic check in FIG. 9.

Generating questions and answers for a trivia game using the received request is performed by one or more agents, which, in some embodiments, are different specialized models trained for specific tasks within method 1200 (e.g., validation models 906a through 906n). The agents are autonomous software components or modules that operate independently to execute specific tasks or functions within a system (e.g., validation framework 1100). For example, one agent specializes in generating initial questions based on the user-inputted request, while another agent specializes in evaluating and refining these questions for clarity and relevance. In some embodiments, the same agent is used for multiple tasks.

In some embodiments, one or more of the agents are implemented as distinct neural network architectures (e.g., transformer-based model, convolutional neural network (“CNN”), recurrent neural network (“RNN”)). In some embodiments, one or more of the agents are rule-based systems using predefined rules and templates to guide the question generation and evaluation processes. The rule-based agents use a set of heuristics (e.g., a collection of rules or guidelines) to generate questions that adhere to specific formats and styles. In some embodiments, the agents are integrated with external knowledge bases or databases to enhance the accuracy and relevance of the questions. For example, the question generation agent accesses a knowledge graph to retrieve up-to-date information on the topic to ensure that the questions are factually correct (e.g., accuracy check in FIG. 9). The self-evaluation agent cross-references the generated questions with the knowledge base to verify the accuracy of the questions generated by the question generation agent.

The agents are, in some embodiments, deployed in a distributed computing environment, where each agent operates on a separate node within a network. The distributed architecture allows for parallel processing of tasks, improving the efficiency and scalability of the system. The question generation agent generates multiple sets of questions simultaneously, while the evaluation agent processes generated questions in parallel. Additionally, in some embodiments, an agent that manages interactions between the various specialized agents. The management agent coordinates the workflow (e.g., method 1200) by, for example, ensuring each task is executed in the correct sequence. In some embodiments, the management agent monitors the capacity and computational load of each agent to dynamically adjust workloads to balance the computational load and prevent bottlenecks. Furthermore, each node operates independently, so if one node fails, the management agent reassigns tasks to other nodes to reduce instances of disruption.

At operation 1204, an agent such as a question writer agent generates an initial set of questions based on the user-inputted request. In some embodiments, the question writer agent is an LLM. For instance, a request such as “Seinfeld” is combined with a predefined system prompt such as “generate X number of questions for the topic (topic)” and included pre-loaded query context (e.g., the pre-loaded query context in FIG. 9). The question writer agent generates one or more types of questions and corresponding answer(s), such as multiple-choice questions, open-ended questions, and/or true/false questions based on the pre-loaded query context.

In multiple-choice formats, the pre-loaded query context includes instructions (e.g., commands) to generate both correct and incorrect answers for each question. For open ended questions, the pre-loaded query context instructs the LLM to provide a prompt that has a descriptive answer (e.g., an answer above a certain number of words). For example, an open-ended question is “Describe the relationship between Jerry and Newman.” The pre-loaded query context for true/false questions, on the other hand, instructs the LLM to generate questions with a binary answer (e.g., “True” or “False”). For example, a true/false question is “True or False: George Costanza is Jerry's best friend.” Furthermore, the pre-loaded query context includes generating questions of one or more categories (e.g., entertainment, geography, history) for a single request. For example, a request such as “Seinfeld” is combined with pre-loaded query context to generate questions across multiple categories such as entertainment, geography, history, and so forth.

In some embodiments, the generated questions are output in a JSON array format. For example, the output of the question writer agent to a topic “Seinfeld” is: [{“question”: “Which character is known for the catchphrase ‘Yada, yada, yada’?”, “correct answer”: “Elaine Benes”, “incorrect answer 1”: “George Costanza”, “incorrect answer 2”: “Kramer”, “incorrect answer 3”: “Jerry Seinfeld”}]. The question writer agent includes metadata in the output (e.g., questions and corresponding answer(s)), such as timestamps, question difficulty levels, and/or topic tags. The metadata provides additional context and enables the filtering and sorting of the output. In some embodiments, the question writer agent tracks/logs the number of tokens processed by the question writer agent during question generation, on a per-question basis and/or for the entire set to determine computational resource usage.

At operation 1206, the generated questions and corresponding answers are evaluated by an agent such as a self-evaluation agent. The self-evaluation agent validates the questions against predetermined model-driven conditions using one or more validation models 906a through 906n. The self-evaluation agent generates an indicator for each question indicating whether the question satisfies the predetermined model-driven conditions. The indicator, in some embodiments, is a binary value (e.g., pass/fail), categorical value (e.g., pass, replace, rewrite), or other score that reflects one or more dimensions evaluated by the validation models 906a through 906n.

For example, the self-evaluation agent determines an indicator such as “pass,” “rewrite,” and/or “replace,” to provide a directive for the subsequent operations. The “pass” indicator signifies that the question has met all (or a predefined amount) of the predetermined model-driven conditions and is ready for inclusion in the trivia game. The “rewrite” indicator suggests that the self-evaluation agent has identified one or more unsatisfied model-driven conditions (e.g., clarity issues, ambiguity issues) in the question and/or answer(s). The “replace” indicator indicates that the self-evaluation agent has identified one or more unsatisfied predetermined model-driven conditions that triggers the method 1200 discard the generated question and replace with a new question (e.g., factual inaccuracy). In some embodiments, the self-evaluation agent outputs an explanation for each question that does not pass that indicates why the question failed one or more of the validation models 906a through 906n. For example, the explanation indicates that a question failed due to ambiguity, factual inaccuracy, and/or lack of relevance to the topic. In some embodiments, the questions that failed due to factual inaccuracy are assigned a “replace” indicator, whereas questions that failed due to ambiguity are assigned a “rewrite” indicator.

For instance, the self-evaluation agent employs machine learning models trained on large datasets of trivia questions to predict the likelihood of a question passing or failing the predetermined model-driven conditions. The models use a variety of features to make their predictions, including question length, complexity, keyword relevance, grammatical correctness, factual accuracy, and/or ambiguity detection. Question length is measured by the number of words or characters. Shorter questions, for example, those with a word count below a predefined threshold (e.g., fewer than 10 words), are flagged for lack of detail, as they may not provide enough context or information. Conversely, longer questions, those exceeding a certain threshold (e.g., more than 30 words), are flagged for verbosity, as the questions and/or answers are overly complex or cumbersome for users to read and understand quickly.

The self-evaluation further assesses complexity using readability metrics such as the Flesch-Kincaid readability score, which evaluates the ease of understanding based on sentence length and word syllable count. Questions with high readability scores, indicating they are difficult to understand, are flagged for being overly complex. The self-evaluation determines keyword relevance by analyzing the presence and frequency of topic-specific keywords within the question and/or answers. The self-evaluation agent uses a predefined list of relevant keywords for each topic and checks if these keywords appear in the question. Questions/answers lacking the keywords or having a frequency below a certain threshold are flagged for being off-topic, ensuring that the questions are pertinent to the specified subject matter.

Grammatical correctness is evaluated by scanning the text for grammatical errors such as subject-verb agreement, incorrect verb tenses, and misplaced modifiers. Further, the self-evaluation agent partitions the generated question/answer into the content's constituent parts (e.g., nouns, verbs, adjectives) and checking the syntactic relationships between them. For instance, a grammar checker flags a sentence such as “Elaine dance at the party” for incorrect subject-verb agreement, and identifies a misplaced modifier in a sentence such as “Eating a big salad, George's satisfaction was evident.” Factual accuracy is checked by cross-referencing the content of the question with verified information from a knowledge base or database. The self-evaluation agent uses entity recognition and fact-checking algorithms to ensure that the information presented in the question is correct. Questions with discrepancies or inaccuracies are flagged for replacement, as they could mislead or confuse users.

The self-evaluation agent detects ambiguity by identifying terms or phrases within the question that could lead to multiple interpretations. For example, the self-evaluation agent tokenizes the question/answers to identify terms and phrases, and uses vector representations such as word embeddings to measure the similarity (e.g., using cosine similarity) between terms and detect potential ambiguities. For instance, in the question “What did George do at the diner?” the verb “do” is vague and could refer to many actions. The self-evaluation agent detects the ambiguity by analyzing the vector representation of “do” and comparing the vector representation with vectors of other potential actions. If the similarity scores indicate that “do” could be interpreted in multiple ways (e.g., similar or close in distance to multiple other vectors), the agent flags the question for rewrite.

At operation 1208, the method 1200 performs a check to determine if the self-evaluation agent's generated indicator indicates that the generated questions have satisfied the predetermined model-driven conditions. For example, the check determines if the indicator indicates a pass or fail (e.g., “rewrite,” “replace,” “fail”). For questions and corresponding answers that pass the self-evaluation (e.g., questions that satisfy the predetermined model-driven conditions), the method 1200 proceeds to operation 1212. Otherwise, for questions and corresponding answers that were rejected (e.g., questions that fail to satisfy the predetermined model-driven conditions), the method 1200 proceeds to operation 1210.

At operation 1210, the question rewrite agent revises the questions and/or corresponding answers in accordance with the self-evaluation agent's generated explanation of why the particular questions failed one or more of the validation models 906a through 906n. The question rewrite agent modifies the questions by rephrasing the questions, supplementing the question with additional context, removes portions of the question, and/or replaces portions of the question. The input to the question rewrite agent is the request, the rejected question(s), and/or the generated explanation of the self-evaluation agent. For examples, for questions categorized as “replace” by the self-evaluation agent are fully rewritten, whereas questions categorized as “rewrite” are modified in accordance with the explanation.

Based on the generated explanation, the question rewrite agent performs different types of modifications. For example, the question rewrite agent uses sequence-to-sequence modeling to generate a syntactically and semantically correct version of the question. Sequence-to-sequence models ingest an input sequence (the original question) and produce an output sequence (the rephrased question). The encoder processes the input sequence and creates a context vector, which the decoder then uses to generate the output sequence. For example, if the original question was “What did George do at the diner?” and the explanation indicated that “do” is too vague, the question rewrite agent rephrases the question to “What food did George order at the diner?” In some embodiments, the question rewrite agent replaces incorrect parts of the question identified by the self evaluation agent. For example, if a question incorrectly refers to a character or event, such as “What did Jerry do at the coffee shop?” when the question should refer to George, the agent replaces “Jerry” with “What did George do at the coffee shop?”

In some embodiments, the input to the question rewrite agent includes one or more questions and corresponding answers that satisfied the predetermined model-driven conditions to prevent the question rewrite agent from outputting similar questions. The question rewrite agent, in some embodiments, uses cosine similarity measures to compare the vector representations of the generated questions with those of the input questions. If the similarity score exceeds a certain threshold, indicating that the generated question is too similar to an existing one, the question rewrite agent discards the question and generate a new candidate.

At operation 1212, once the questions and corresponding answers are rewritten/replaced and pass the self-evaluation, an agent such as a search term creation agent generates search terms related to the rewritten/replaced questions and the approved questions. In some embodiments, all (or a predefined amount) of the rewritten/replaced and approved questions along with their corresponding answers are collected into a single batch and sent to the search term creation agent. In other embodiments, each question and the question's corresponding answer are prepared as individual queries and sent separately to the search term creation agent.

The pre-loaded query context includes commands/instructions for the search term creation agent to output one or more tokens (e.g., words, phrases) used to search for a citation source for the question(s). The search term creation model, which could be a transformer-based model (e.g., GPT) or a simpler rule-based system, generates a list of potential search terms for each question-answer pair by identifying phrases and entities in the question and answer and generating synonyms and related terms using a thesaurus or pre-trained language model. The search term creation agent uses the similarity (e.g., cosine similarity, Euclidean distance) between the search terms and the vector representations of the tokenized questions/answers to ensure the search terms are relevant to the context of the questions and answers. For example, search terms with a smaller distance (higher similarity) are considered more relevant and are prioritized.

The search terms are used to find supporting information and citations in operation 1214. At operation 1214, the search terms are sent to an API (e.g., Brave Search API), which retrieves one or more citations (e.g., snippets) from one or more sources. The search term creation agent sends the generated search terms to the API endpoint, which processes the request and queries a database or external sources to find relevant citations. The API uses the search terms to match against indexed content, retrieving citations of information that are contextually relevant to the search terms. The citations, such as snippets, are pieces of information that support the content of the questions and answers. The API returns the citations to the search term creation agent, which associates the citations with the corresponding questions and answers.

At operation 1216, an agent such as a citations editor agent receives the questions and answers along with their associated citations and verifies that each question-answer pair is supported by the required number of unique citations (e.g., by at least three unique citations retrieved by operation 1214). The citations editor agent obtains one or more questions and corresponding answers evaluated by operation 1214 and outputs an indicator indicating the source(s) supporting the questions and corresponding answer. If the citations editor agent identifies that a question-answer pair is supported by the required number of citations, the citations editor agent outputs an indicator confirming the validation. In some embodiments, if the citations editor agent fails to identify the supporting sources (e.g., the citations editor agent only identifies two sources, but three are required), the citations editor agent outputs a corresponding explanation of the indicator. This explanation details why the validation failed, such as the lack of sufficient unique citations.

In some embodiments, the input into the citations editor agent is annotated to indicate, to the citations editor agent, portions of the output of the API to focus on. For example, when the API retrieves citations, the citations editor agent or another preprocessing agent analyzes the content to identify the most relevant sections using NLP techniques such as named entity recognition (“NER”) to identify entities, keyword extraction to tag the main topic/themes, or semantic similarity measures. The tags are markers (e.g., Hypertext Markup Language (“HTML”) tags, JSON keys) that indicate the start and end of relevant sections. The annotations reduce token usage by enabling the citations editor agent to process the information without expending unnecessary computational resources on irrelevant data.

At operation 1218, if the citations editor agent is able to find support, such as three unique sources, the method continues to operation 1224. Otherwise, the method 1200 proceeds to operation 1220. At operation 1220, the method 1200 checks if there are any queries left that. If there are, the method proceeds back to operation 1214 to send the next search term to query the API for results to attempt to find additional citations. If there are no more queries left to process, the method exits the loop at operation 1222. The exit point indicates that all (or a predefined amount) of the possible search terms have been queried and the citations editor agent has either found the necessary support or failed to find sufficient citations with the available search terms. Exiting the loop at operation 1222 results in the pair being flagged for further review, revision, or rejection.

At operation 1224, the questions are subject to a review by an agent such as an assessment agent. The predefined query context of the assessment agent includes, for example, a verification by one or more validation models 906a through 906n of the sources retrieved by the API and/or the question and corresponding answers. For example, the predefined query context instructs the assessment agent to evaluate the content of the question and corresponding answers under a localization text and output an indicator indicating a relevance of the question and corresponding answer to a language and/or market (e.g., “1” corresponds to not relevant to the language/market, whereas “10” corresponds to highly relevant to the language/market).

In some embodiments, the assessment agent tags the question and corresponding answers with one or more metadata tags. For example, the metadata tags are a predefined list of topics used to categorize the generated questions and corresponding answers (e.g., “Religion,” “Cuisine,” “Video Games”). These tags are stored in a structured format, such as JSON or Extensible Markup Language (“XML”), alongside the content for retrieval in future queries. The assessment agent formats each question/answer pair in a predefined format (e.g., JSON) that indicates the question, answers, supporting sources, question format, and/or metadata tags.

At operation 1226, if the questions satisfy the predetermined model-driven conditions of the validation models used in operation 1224, the method 1200 proceeds to operation 1232. If not, the method 1200 checks the rewrite count at operation 1228. The method 1200 maintains a counter that tracks the number of times each question has been revised. If the counter is below the threshold (e.g., three), the content is sent back to operation 1210 for further revision, where the content is subject to another round of rewriting and validation. If the counter exceeds the threshold, the method 1200, at operation 1230, prevents the questions from proceeding to operation 1210, and flags the question for review or rejection.

At operation 1232, the loop continues until a predefined number (e.g., all questions, such as 36 for a trivia set) questions are assessed via the assessment agent (e.g., to ensure that a complete set of trivia questions is generated). A counter tracks the number of questions processed. Each time a question passes the validation checks, the counter increments. If a question fails validation, the question is sent back for revision, and the loop continues with the next question. The loop only terminates when the counter reaches the predefined number, indicating that the complete set of questions/answers has been successfully generated and validated.

At operation 1234, the questions and corresponding answers appear on a graphical user interface (“GUI”) (e.g., front-end interface 1102), where the questions are ready for use in a game such as a trivia game. In some embodiments, the questions appearing on the GUI in operation 1234 are evaluated by one or more human agents prior to inputting the questions and corresponding answers into the trivia game.

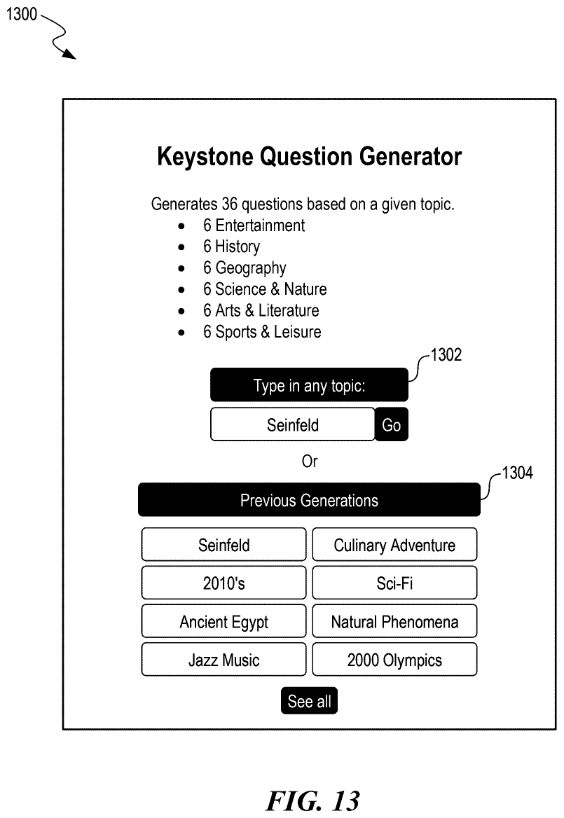

FIG. 13 is one embodiment of a front-end interface 1300 as applied to generating questions and answers for a trivia game. The front-end interface 1300 includes topic indicator 1302 and previous generation indicator 1304. The front-end interface 1300 is implemented using components of the example computer system 1700 illustrated and described in more detail with reference to FIG. 17. Embodiments of the front-end interface 1300 can include different and/or additional components or can be connected in different ways.

The topic indicator 1302 enables users to input or select a topic for which they want to generate trivia questions. For example, the topic indicator 1302 includes a text input field, a dropdown menu, or other selection mechanisms. For example, a dropdown menu includes a list of predefined topics to enable users to select from popular or commonly requested topics without typing the topics out fully. In some embodiments, other selection mechanisms include voice input using speech recognition technology, which converts spoken words into text and matches them against the predefined list of topics or generates new topics based on the recognized speech. In some embodiments, the topic indicator 1302 enables users to choose multiple topics simultaneously (e.g., using checkboxes or a multi-select dropdown menu) to generate trivia questions that span several topics.

The previous generation indicator 1304 provides information about the last set of questions generated, including details such as the number of questions, the topic, and/or the time of generation to help users keep track of their previous activities and avoid generating duplicate questions. For instance, if a user generated 20 questions on the topic “Seinfeld” previously (e.g., in the same session or in a previous session), the previous generation indicator 1304 indicates the topic, enabling the user to decide whether to generate more questions on the same topic or choose a different one. The indicator, in some embodiments, includes additional details such as the difficulty level of the questions, the format (e.g., multiple-choice, true/false), and/or any metadata tags.

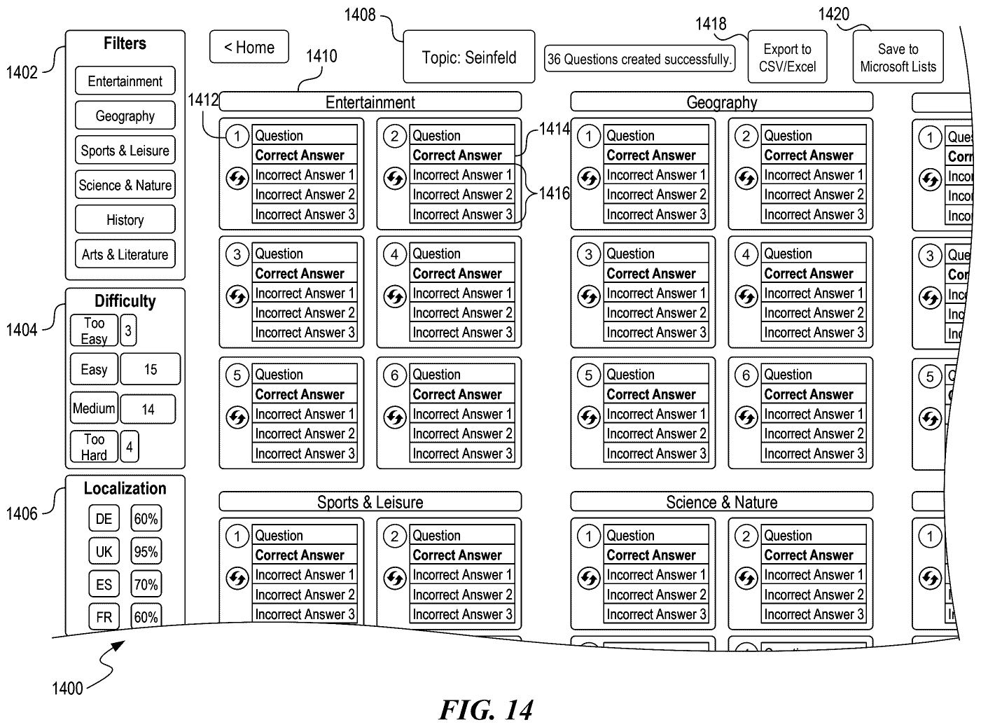

FIG. 14 is one embodiment of a front-end interface 1400 displaying the generated questions and answers for the trivia game. The front-end interface 1400 includes filters 1402, difficulties 1404, localizations 1406, topic 1408, dimension 1410, question 1412, correct answer 1414, incorrect answers 1416, export indicator 1418, and storage indicator 1420. The front-end interface 1400 is implemented using components of the example computer system 1700 illustrated and described in more detail with reference to FIG. 17. Embodiments of the front-end interface 1400 can include different and/or additional components or can be connected in different ways.

The filters 1402 allow users to refine the displayed questions based on specific dimensions 1410 (e.g., categories such as “Entertainment,” “Geography”) helping users find and manage the questions. The difficulties 1404 component enables users to categorize questions by difficulty level, such as “easy,” “medium,” and “hard,” or custom levels defined by the user to ensure that the questions are appropriate for the intended audience. The localizations 1406 component allows users to generate and display questions in different languages or regional variations, by selecting the desired language or region from a dropdown menu or other selection mechanism.

The topic 1408 component displays the topic for which the questions have been generated. The dimension 1410 component provides additional context or categorization for the questions, such as subtopics or themes, to help organize the questions more effectively. The question 1412 component displays the generated trivia questions. The correct answer 1414 component displays the correct answer for each trivia question, and likewise, the incorrect answers 1416 component displays the incorrect answers for each trivia question. The export indicator 1418 allows users to export the generated questions and answers in various formats, such as JSON, CSV, or PDF to share or integrate the questions into different systems or applications. The storage indicator 1420 enables the storage of the generated questions and answers.

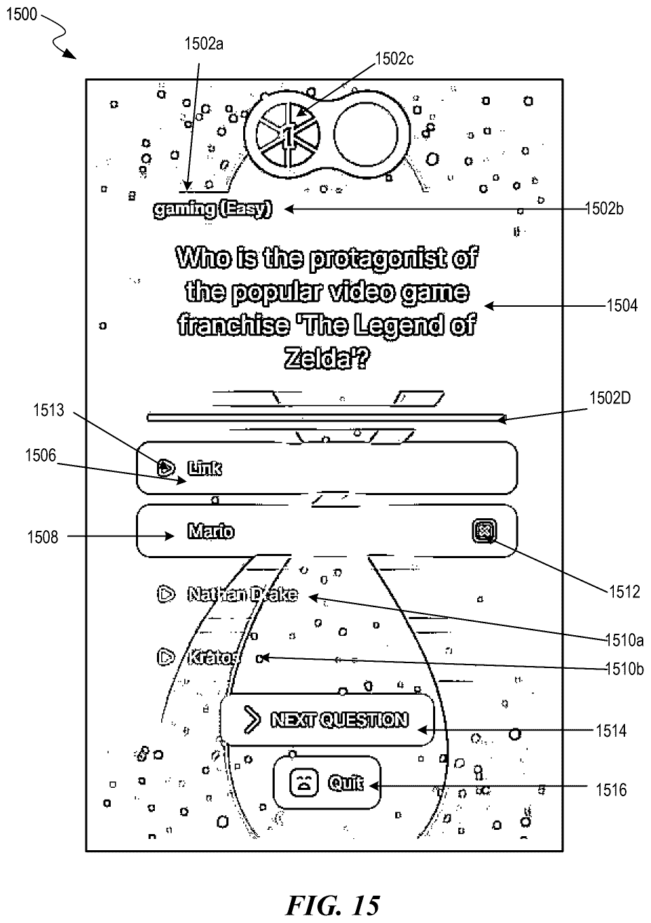

FIG. 15 is a screenshot of one embodiment of the front-end interface 1500 as applied to a trivia game. In some embodiments, the front-end interface 1500 includes headers 1502. In some embodiments, the headers 1502 include a variety of information helpful to the user, such as the user-requested topic 1502a or the difficulty level of the trivia game 1502b. Further headers include, but are not limited to: 1) a timer 1502d that displays the remaining time for answering each question, and 2) a progress indicator 1502c graphically represents the user's advancement through the trivia game, providing a tangible sense of achievement and urgency.

A question 1504 is displayed on the front-end interface 1500. In some embodiments, below each question 1504, a set of answer options (1506, 1508, 1510a, 1510b) is presented, allowing users to select their preferred answer by clicking or tapping the corresponding option. Additionally, in some embodiments, one or more supplementary features like a leaderboard, social sharing options, or in-game chat functionality are integrated into the interface, depending on the game's design. Once the user submits their answer, the incorrect answer 1508 is highlighted with a second visual icon 1512, and similarly, the correct answer 1506 is highlighted using a first visual icon 1513. In some embodiments, selected answers 1506 are visually highlighted for clarity. In some embodiments, there is a progression button 1514 that enables users to advance to the next question, ensuring a fluid and uninterrupted gameplay experience. In some embodiments, there is a quitting button 1516, configured so that the user can leave the gaming experience at any time.

### Computing Platform

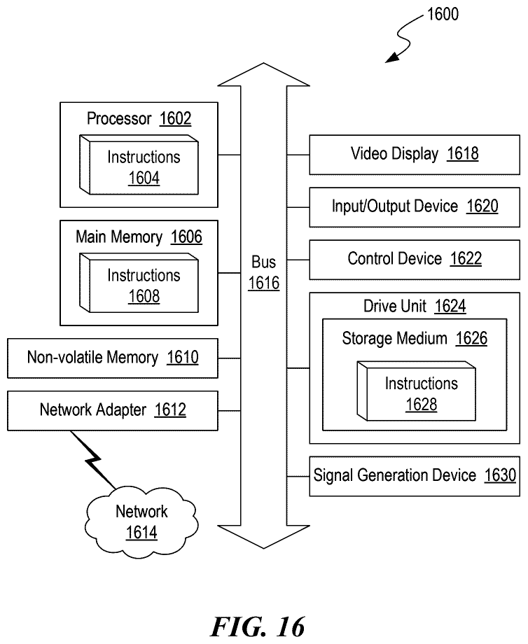

FIG. 16 is a block diagram illustrating an example computer system 1600, in accordance with one or more embodiments. In some embodiments, components of the example computer system 1600 are used to implement the software platforms described herein. At least some operations described herein can be implemented on the computer system 1600.

In some embodiments, the computer system 1600 includes one or more central processing units (“processors”) 1602, main memory 1606, non-volatile memory 1610, network adapters 1612 (e.g., network interface), video displays 1618, input/output devices 1620, control devices 1622 (e.g., keyboard and pointing devices), drive units 1624 including a storage medium 1626, and a signal generation device 1620 that are communicatively connected to a bus 1616. The bus 1616 is illustrated as an abstraction that represents one or more physical buses and/or point-to-point connections that are connected by appropriate bridges, adapters, or controllers. The bus 1616, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1694 bus (also referred to as “Firewire”).

In some embodiments, the computer system 1600 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1600.

While the main memory 1606, non-volatile memory 1610, and storage medium 1626 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1628. The term “machine-readable medium” and “storage medium” shall also be taken to include any medium that is capable of storing, encoding, or carrying a set of instructions for execution by the computer system 1600. In some embodiments, the non-volatile memory 1610 or the storage medium 1626 is a non-transitory, computer-readable storage medium storing computer instructions, which is executable by the one or more “processors” 1602 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1604, 1608, 1628) set at various times in various memory and storage devices in a computer device. When read and executed by the one or more processors 1602, the instruction(s) cause the computer system 1600 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory 1610 devices, floppy and other removable disks, hard disk drives, optical discs (e.g., compact disc read-only memory (CD-ROMS), digital versatile discs (DVDs)), and transmission-type media such as digital and analog communication links.

The network adapter 1612 enables the computer system 1600 to mediate data in a network 1614 with an entity that is external to the computer system 1600 through any communication protocol supported by the computer system 1600 and the external entity. The network adapter 1612 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1612 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1700 illustrated and described in more detail with reference to FIG. 17.

### AI System

FIG. 17 is a high-level block diagram illustrating an example AI system, in accordance with one or more embodiments. The AI system 1700 is implemented using components of the example computer system 1600 illustrated and described in more detail with reference to FIG. 16. Likewise, embodiments of the AI system 1700 include different and/or additional components or be connected in different ways.

In some embodiments, as shown in FIG. 17, the AI system 1700 includes a set of layers, which conceptually organize elements within an example network topology for the AI system's architecture to implement a particular AI model 1730. Generally, an AI model 1730 is a computer-executable program implemented by the AI system 1700 that analyses data to make predictions. Information passes through each layer of the AI system 1700 to generate outputs for the AI model 1730. The layers include a data layer 1702, a structure layer 1704, a model layer 1706, and an application layer 1708. The algorithm 1716 of the structure layer 1704 and the model structure 1720 and model parameters 1722 of the model layer 1706 together form the example AI model 1730. The optimizer 1726, loss function engine 1724, and regularization engine 1728 work to refine and optimize the AI model 1730, and the data layer 1702 provides resources and support for the application of the AI model 1730 by the application layer 1708.

The data layer 1702 acts as the foundation of the AI system 1700 by preparing data for the AI model 1730. As shown, in some embodiments, the data layer 1702 includes two sub-layers: a hardware platform 1710 and one or more software libraries 1712. The hardware platform 1710 is designed to perform operations for the AI model 1730 and includes computing resources for storage, memory, logic, and networking, such as the resources described in relation to FIG. 17. The hardware platform 1710 processes amounts of data using one or more servers. The servers can perform backend operations such as matrix calculations, parallel calculations, machine learning (ML) training, and the like. Examples of servers used by the hardware platform 1710 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1710 includes Infrastructure as a Service (IaaS) resources, which are computing resources, (e.g., servers, memory, etc.) offered by a cloud services provider. In some embodiments, the hardware platform 1710 includes computer memory for storing data about the AI model 1730, application of the AI model 1730, and training data for the AI model 1730. In some embodiments, the computer memory is a form of random-access memory (RAM), such as dynamic RAM, static RAM, and non-volatile RAM.

In some embodiments, the software libraries 1712 are thought of as suites of data and programming code, including executables, used to control the computing resources of the hardware platform 1710. In some embodiments, the programming code includes low-level primitives (e.g., fundamental language elements) that form the foundation of one or more low-level programming languages, such that servers of the hardware platform 1710 can use the low-level primitives to carry out specific operations. The low-level programming languages do not require much, if any, abstraction from a computing resource's instruction set architecture, allowing them to run quickly with a small memory footprint. Examples of software libraries 1712 that can be included in the AI system 1700 include Intel Math Kernel Library, Nvidia cuDNN, Eigen, and Open BLAS.

In some embodiments, the structure layer 1704 includes an ML framework 1714 and an algorithm 1716. The ML framework 1714 can be thought of as an interface, library, or tool that allows users to build and deploy the AI model 1780. In some embodiments, the ML framework 1714 includes an open-source library, an application programming interface (API), a gradient-boosting library, an ensemble method, and/or a deep learning toolkit that works with the layers of the AI system facilitate development of the AI model 1730. For example, the ML framework 1714 distributes processes for the application or training of the AI model 1730 across multiple resources in the hardware platform 1710. In some embodiments, the ML framework 1714 also includes a set of pre-built components that have the functionality to implement and train the AI model 1730 and allow users to use pre-built functions and classes to construct and train the AI model 1730. Thus, the ML framework 1714 can be used to facilitate data engineering, development, hyperparameter tuning, testing, and training for the AI model 1730. Examples of ML frameworks 1714 that can be used in the AI system 1700 include TensorFlow, PyTorch, Scikit-Learn, Keras, Caffe, LightGBM, Random Forest, and Amazon Web Services.

In some embodiments, the algorithm 1716 is an organized set of computer-executable operations used to generate output data from a set of input data and can be described using pseudocode. In some embodiments, the algorithm 1716 includes complex code that allows the computing resources to learn from new input data and create new/modified outputs based on what was learned. In some implementations, the algorithm 1716 builds the AI model 1730 through being trained while running computing resources of the hardware platform 1710. The training allows the algorithm 1716 to make predictions or decisions without being explicitly programmed to do so. Once trained, the algorithm 1716 runs at the computing resources as part of the AI model 1730 to make predictions or decisions, improve computing resource performance, or perform tasks. The algorithm 1716 is trained using supervised learning, unsupervised learning, semi-supervised learning, and/or reinforcement learning.

The application layer 1708 describes how the AI system 1700 is used to solve problems or perform tasks. In an example implementation, the application layer 1708 includes the ML framework 1714.

As an example, to train an AI model 1730 that is intended to model human language (also referred to as a language model), the data layer 1702 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 1702 is annotated with ground truth labels (e.g., each data entry in the training dataset is paired with a label), or unlabeled.

Training an AI model 1730 generally involves inputting into an AI model 1730 (e.g., an untrained ML model) data layer 1702 to be processed by the AI model 1730, processing the data layer 1702 using the AI model 1730, collecting the output generated by the AI model 1730 (e.g., based on the inputted training data), and comparing the output to a desired set of target values. If the data layer 1702 is labeled, the desired target values, in some embodiments, are, e.g., the ground truth labels of the data layer 1702. If the data layer 1702 is unlabeled, the desired target value is, in some embodiments, a reconstructed (or otherwise processed) version of the corresponding AI model 1730 input (e.g., in the case of an autoencoder), or is a measure of some target observable effect on the environment (e.g., in the case of a reinforcement learning agent). The parameters of the AI model 1730 are updated based on a difference between the generated output value and the desired target value. For example, if the value outputted by the AI model 1730 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 1730 typically is to minimize a loss function or maximize a reward function.

In some embodiments, the data layer 1702 is a subset of a larger data set. For example, a data set is split into three mutually exclusive subsets: a training set, a validation (or cross-validation) set, and a testing set. The three subsets of data, in some embodiments, are used sequentially during AI model 1730 training. For example, the training set is first used to train one or more ML models, each AI model 1730, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 1730. Backpropagation is used to adjust (also referred to as update) the value of the parameters in the AI model 1730, with the goal of optimizing the objective function. For example, a defined loss function is calculated by forward propagation of an input to obtain an output of the AI model 1730 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 1730 are used. The process of updating (or learning) the parameters over many iterations is referred to as training. In some embodiments, training is carried out iteratively until a convergence condition is met (e.g., a predefined maximum number of iterations has been performed, or the value outputted by the AI model 1730 is sufficiently converged with the desired target value), after which the AI model 1730 is considered to be sufficiently trained. The values of the learned parameters are then fixed and the AI model 1730 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 1730 typically involves further training the ML model on a number of data samples (which may be smaller in number/cardinality than those used to train the model initially) that closely target the specific task. For example, an AI model 1730 for generating natural language that has been trained generically on publicly available text corpora is, e.g., fine-tuned by further training using specific training samples. In some embodiments, the specific training samples are used to generate language in a certain style or a certain format. For example, the AI model 1730 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a LLM contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt, which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as an LLM, which is a LLM based on an encoder-decoder architecture, and can simultaneously perform text generation and text understanding. The llama2 selects or trains proper pre-training corpus, pre-training targets and pre-training parameters according to different tasks and fields, and adjusts an LLM on the basis so as to improve the performance of the LLM under a specific scene.

In some embodiments, the Falcon40B is used as an LLM, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as an LLM, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

We claim:

1. A method for delivering personalized trivia content in an interactive game environment, comprising:
providing (a) a game application having a client-side user interface and a backend host configured to control communications between the client-side user interface and a generative artificial intelligence (AI) model, and (b) a plurality of tangible game elements associated with the game application, each tangible game element provided with at least one machine-readable identifier that represents a topic or category of a question-and-answer set;
receiving, via the client-side user interface of the game application, a selected topic-category combination via a client-side user interface scan of (a) a first machine-readable identifier of a first tangible game element that represents a particular topic and (b) a second machine-readable identifier of a second tangible game element that represents a particular category;
storing, in a database coupled to the game application, a plurality of cache records that each indicates a question-answer set transmitted from the backend host of the game application to a given instance of the client-side user interface, wherein each question-answer set corresponds to each topic-category combination transmitted from the given instance of the client-side user interface to the backend host;
determining that the plurality of cache records associated with the selected topic-category combination includes a particular question-answer set that is within a similarity threshold of a previous question-answer set presented previously through the client-side user interface;
in response to said determination, generating, via the backend host, a command set for the AI model by populating a structured data template with data corresponding to the selected topic-category combination, wherein the structured data template includes placeholder tokens configured to be replaced with the data corresponding to the selected topic-category combination at respective locations of the placeholder tokens within the structured data template,
transmitting the populated structured data template to the AI model, wherein the AI model is trained to generate a new question-answer set in accordance with the selected topic-category combination; and
causing presentation of the new question-answer set through the client-side user interface.

2. The method of claim 1, wherein the given instance uniquely identifies one or more game sessions associated with a game account of the game application.

3. The method of claim 2,
wherein a particular user identifier is received via an API call transmitted via the backend host, and
wherein the plurality of cache records is associated with the particular user identifier.

4. The method of claim 2, further comprising:
blocking, via the backend host, transmission of user-supplied input received from the client-side user interface that is different from the populated structured data template to the AI model.

5. The method of claim 1, further comprising:
determining, via the backend host, that a count of unused question-answer sets stored in the database for a particular topic-category combination is less than a predetermined threshold;
in response to said determination, generating, via the backend host, an additional command set for the AI model to generate one or more additional question-answer sets for the particular topic-category combination; and
storing the one or more additional question-answer sets in the database.

6. The method of claim 5,
wherein the count of unused question-answer sets for each topic-category combination is maintained collectively for multiple users, and
wherein said generation of the command set is triggered when a collective count for a particular topic-category combination across the multiple users falls below the predetermined threshold.

7. The method of claim 1, wherein the AI model is applied to the selected topic-category combination subsequent to scanning (a) the first machine-readable identifier of the first tangible game element and (b) the second machine-readable identifier of the second tangible game element.

8. The method of claim 1, wherein the AI model is applied to the selected topic-category combination prior to scanning (a) the first machine-readable identifier of the first tangible game element and (b) the second machine-readable identifier of the second tangible game element.

9. The method of claim 1, wherein the AI model is configured to output, responsive to receiving the selected topic-category combination, the particular question-answer set and one or more of:
a summary of the particular question-answer set, an explanation describing the particular question-answer set,
a hint generated based on at least one keyword or fact related to the particular question-answer set, or
a citation to one or more sources used to validate the particular question-answer set.

10. A method for delivering personalized trivia content in an interactive game environment, comprising:
providing (a) a game application having a client-side user interface and a backend host configured to control communications between the client-side user interface and a generative artificial intelligence (AI) model, and (b) a plurality of tangible game elements associated with the game application, wherein each tangible game element is associated with at least one identifier that represents a value of a game parameter type;
obtaining, via a user interface of the game application, a selected query context combination based on (a) a first identifier associated with a first tangible game element that represents a first value of a first game parameter type and (b) a second identifier associated with a second tangible game element that represents a second value of a second game parameter type;
maintaining, in a database coupled to the game application, a plurality of cache records that each indicates game content transmitted from the backend host of the game application to a given instance of the client-side user interface, wherein each game content corresponds to each query context combination transmitted from the given instance of the client-side user interface to the backend host;
determining that the plurality of cache records associated with the selected query context combination includes a particular game content that is different from previous game content presented previously through the client-side user interface;
in response to said determination:
blocking, via the backend host, an indication of the selected query context combination from being transmitted to the AI model, and
transmitting, via the backend host, the particular game content indicated by a particular cache record of the plurality of cache records to the client-side user interface, wherein the particular cache record is associated with the selected query context combination; and
causing presentation of the particular game content through the client-side user interface.

11. The method of claim 10, further comprising:
in response to causing the presentation of the particular game content through the user interface:
automatically transmitting, via the game application, an indication of the selected query context combination to the AI model, and
receiving, from the AI model, a replacement game content generated responsive to the selected query context combination, wherein the AI model is configured to generate the replacement game content during an expected user interactivity time associated with the particular game content.

12. The method of claim 10, further comprising, prior to causing presentation of the particular game content through the user interface:
evaluating, using one or more validation models, the particular game content to determine satisfaction of the particular game content with a predetermined model-driven condition, wherein the predetermined model-driven condition is directed by a query context assigned to the one or more validation models.

13. The method of claim 10, wherein the database maintains, for each cache record of the plurality of cache records, metadata indicating a difficulty level of respective game content, further comprising:
receiving, via the user interface of the game application, an indication of a predefined difficulty level, wherein the particular cache record includes respective metadata that indicates the predefined difficulty level.

14. The method of claim 10, wherein the at least one identifier associated with each tangible game element includes one or more of:
a quick-response (QR) code printed on the tangible game element,
an ArUco code affixed to the tangible game element,
a universally unique identifier (UUID) encoded on the tangible game element, audio data associated with the tangible game element, or
a radio-frequency identification (RFID) tag embedded within the tangible game element.

15. A system for delivering personalized trivia content during a game, comprising:
a plurality of tangible game elements, wherein each tangible game element comprises:
a category face displaying a category value selected from a predefined set of categories associated with the game,
a topic face displaying a topic value selected from predefined set of topics associated with the game, and
at least one identifier displayed on each face, each identifier uniquely associated with a corresponding category or topic value;
a client-side user interface configured to receive user input that represents a selection of (a) a particular topic face of a first tangible game element associated with a first user and (b) a particular category face of a second tangible game element associated with a second user;
a database that stores a plurality of cache records, wherein each cache record indicates game content transmitted to a given instance of the client-side user interface, wherein each game content corresponds to (a) a respective topic value of the particular topic face and (b) a respective category value of the particular category face represented in a respective user input received via the client-side interface; and
a backend host configured to control communications between the client-side user interface, the database, and an artificial intelligence (AI) model, wherein the backend host is configured to:
determine that the plurality of cache records stored within the database includes at least one game content that is within a similarity threshold of a previous game content presented previously through the client-side user interface,
in response to said determination, transmitting, via the backend host, a command set to the AI model, wherein the AI model is trained to generate a particular game content in accordance with the particular topic face and the particular category face, and
causing presentation of the particular game content through the client-side user interface.

16. The system of claim 15,
wherein each tangible game element is a card, and
wherein the category face and the topic face are different faces of the card.

17. The system of claim 15, wherein the backend host is further configured to prevent direct communication between the client-side user interface and the AI model by:
validating that data represented within the command set satisfies predetermined criteria prior to transmitting the command set to the AI model.

18. The system of claim 15, wherein the backend host is further configured to:
validate that the particular game content generated via the AI model satisfies predetermined criteria, and
In response to said validation, causing the presentation of the particular game content through the client-side user interface.

19. The system of claim 15, wherein the client-side user interface is further configured to:
receive, for one or more game content indicated by one or more cache records in the plurality of cache records, user feedback that indicates alignment of the one or more game content with a set of criteria; and
responsive to the user feedback failing to satisfy a predefined threshold associated with the set of criteria, automatically remove the one or more cache records from the database.

20. The system of claim 15, wherein the backend host is further configured to:
evaluate, using one or more validation models, the particular game content to determine satisfaction of the particular game content with a predetermined model-driven condition that is directed by a query context assigned to the one or more validation models; and
in response to the particular game content failing to satisfy the predetermined model-driven condition, automatically transmit, via the backend host, an indication of the particular topic face and the particular category face to the AI model.
